(19) United States
(12) Patent Application Publication
(10) Pub. No.: US 2002/0123914 A1
(43) Pub. Date: Sep. 5, 2002

(54) Automated information processing system for container recycling and collection

(76) Inventors: David Kane, Long Beach, CA (US); George Kane, Long Beach, CA (US)

Correspondence Address: Richard C. Litman, LITMAN LAW OFFICES, LTD., P.O. Box 15035, Arlington, VA, 22215, US

(21) Appl. No.: 09/796,347

(22) Filed: Mar. 2, 2001

(51) Int. Cl. G06F 17/60; G06G 1/14

(52) U.S. Cl. 705/7; 705/22; 705/23

(57) ABSTRACT

An automated information processing system for collecting and analyzing transactional information pertaining to recycled beverage containers. The automated information processing system includes a first client, a second client, and a server, each system component being in communication with other components of the system via a connection to the Internet. The first client is a dedicated for use by a government agency and is specially programmed for producing reports, graphs, and charts of collected data. The second client is specially programmed for processing and managing recycling data generated at a certified recycling establishment. The server is specially programmed for providing a central depository for collection and storage of data produced by the information processing system.

### BACKGROUND OF THE INVENTION

1. Field of the Invention

The present invention relates to an automated information processing system and, more specifically, to an network-based automated information processing system for collecting and analyzing transactional information relating to beverage container recycling.

2. Description of the Related Art

With the advent of electronic point of sale terminals, cash registers and the like, large amounts of data are now gathered and stored at the point of sale of goods and services. Such data will typically include the identification and price of items sold, the date and time of sales, and the employee or cashier making the sales. In addition, electronic point of sale (POS) terminals may be programmed to make simple arithmetic computations and store the results of these computations. The extensive data gathering capabilities of modern electronic POS terminals give business managers a powerful tool in the evaluation and management of important business activities. The data gathered, computed and stored in POS terminals, however, has only minimal value in its raw form. The sheer volume of raw data that is now collected presents substantial challenges to those seeking to monitor and process that data to better manage their business activities. A further obstacle to the effective analysis and evaluation of point of sale data lies in the fact that there is no standardized format for collecting and outputting the data. Each make of electronic terminal and its associated polling package collects and outputs different bits of information in different formats or configurations. Much can be learned about the business if the point of sale data can be compiled in a useable format, analyzed and compared to desired criteria to evaluate and manage related business activities.

One method that has been used to analyze cash register data utilizes text files constructed from the raw data collected from the cash registers. The raw data is collected from the various cash registers and assembled into a set of text files. Data collection and text file assembly is accomplished using polling software packages such as Panasonic® Polling Software, which is used in conjunction with Panasonic® cash registers. The text files are reformatted into spreadsheets using commercially available spreadsheet software packages customized to reformat the point of sale data. The data is reformatted and analyzed by application of a set of discrete computer programs, commonly referred to as “macros.” Each set of macros will typically represent one of the business activities being evaluated being evaluated by the user. For example, a set of spreadsheet macros might be formulated to analyze labor productivity by identifying relevant data in the text files and then using that data to compute the desired values according to predetermined formulas.

Several patent references describe state of the art information processing systems. For example, U.S. Pat. No. 4,319,336 issued on Mar. 9, 1982 to Robert W. Anderson et al. describes a transaction execution system with improved key function.

U.S. Pat. No. 4,558,212 issued on Dec. 10, 1985 to Alfred A. Hampson describes a method and apparatus for selective sorting, separating, and redemption-handling of redeemable food containers, such as beverage containers.

U.S. Pat. No. 4,829,428 issued on May 9, 1989 to David H. Weitzman et al. describes a beverage container sorting, accounting, and disposal method with compartmentalized hamper and can crusher.

U.S. Pat. No. 5,052,504 issued on Oct. 1, 1991 to Tetsuo Ikeda et al. describes a sales data transmission system that includes a sales data processor.

U.S. Pat. No. 5,153,585 issued on Oct. 6, 1992 to Fumio Negishi et al. describes an electronic input-display apparatus. More specifically, the invention relates to an automated statistical data collection system that monitors and records computer system terminal generated events.

U.S. Pat. No. 5,355,327 issued on Oct. 11, 1994 to Robert J. Stent et al. describes an automated statistical data collection system for monitoring and recording computer system terminal generated events. More specifically, the system consists of an electronic storage and computing system wherein raw point of sale data is transformed into a predefined standardized configuration from which object values representing select business activities are derived and compared to predefined reference values for the selected activities. The system includes an electronic storage device for storing raw point of sale data, a data interpreter for transforming the raw data into a predefined standardized configuration, and a processor for deriving object values form the transformed data according to a set of mathematical/relational functions, the object values being representative of selected business activities, and comparing the object values to predefined reference values for the selected business activities.

U.S. Pat. No. 5,406,035 issued on Apr. 11, 1995 to Gebhard Wallisch describes a price-indicating electronic apparatus for selling individual articles from a number of different goods.

U.S. Pat. No. 5,566,066 issued on Oct. 15, 1996 to David H. Weitzman et al. describes a method of recycling or redemption for returning empty beverage containers to a retail establishment.

U.S. Pat. No. 5,596,493 issued on Jan. 21, 1997 to Kaoru Tone et al. describes a method for classifying sale amount characteristics, a method for predicting sale volume, a method for ordering for restocking, a system for classifying sale amount characteristics, and a system for ordering for restocking.

U.S. Pat. No. 5,699,525 issued on Dec. 16, 1997 to Ichiro Embutsu et al. describes an information management apparatus dealing with waste and waste recycle planning supporting apparatus.

U.S. Pat. No. 5,774,872 issued on Jun. 30, 1998 to Richard Golden et al. describes an automated taxable transaction reporting/collection system.

U.S. Pat. No. 5,895,453 issued on Apr. 20, 1999 to Kathleen Cook describes a method and system for the detection, management, and prevention of losses in retail and other environments.

U.S. Pat. No. 5,924,077 issued on Jul. 13, 1999 to David Beach et al. describes a computer based system for monitoring and processing data collected at the point of sale of goods and services.

U.S. Pat. No. 5,965,858 issued on Oct. 12, 1999 to Tatsuya Suzuki et al. describes a manufactured article recycling system for promoting a proper recycle of discarded articles.

None of the above inventions and patents, taken either singularly or in combination, is seen to describe the instant invention as claimed. Thus a recycling and collection system solving the aforementioned problems is desired.

### SUMMARY OF THE INVENTION

The present invention is an automated information processing system for collecting and analyzing transactional information pertaining to recycled beverage containers. The automated information processing system includes a first client, a second client, and a server, each system component being in communication with other components of the system via a connection to the Internet. The first client is a dedicated for use by a government agency and is specially programmed for producing reports, graphs, and charts of collected data. The second client is specially programmed for processing and managing recycling data generated at a certified recycling establishment. The server is specially programmed for providing a central depository for collection and storage of data produced by the information processing system.

Accordingly, it is a principal object of the invention to provide an automated information processing system for collecting and analyzing transactional information relating to beverage container recycling.

It is another object of the invention to provide an automated information processing system that can be utilized on the Internet network.

It is a further object of the invention to . . .

Still another object of the invention is to . . .

It is an object of the invention to provide improved elements and arrangements thereof for the purposes described which is inexpensive, dependable and fully effective in accomplishing its intended purposes.

These and other objects of the present invention will become readily apparent upon further review of the following specification and drawings.

### BRIEF DESCRIPTION OF THE DRAWINGS

FIG. 1 is a block diagram of a preferred automated information processing system for monitoring and analyzing bottle recycling activities.

FIG. 2 is a block diagram of a preferred work station setup according to the present invention.

FIG. 3 is a flowchart of a preferred automated process for a processor according to the present invention.

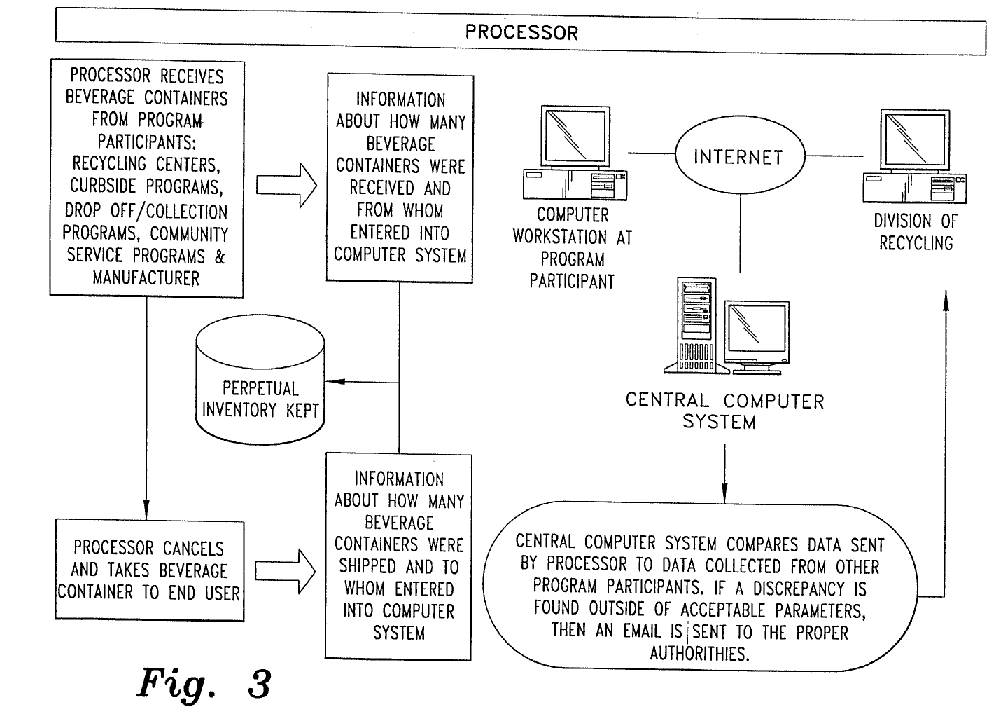

FIG. 4 is a flowchart of a preferred automated process for a recycling center according to the present invention.

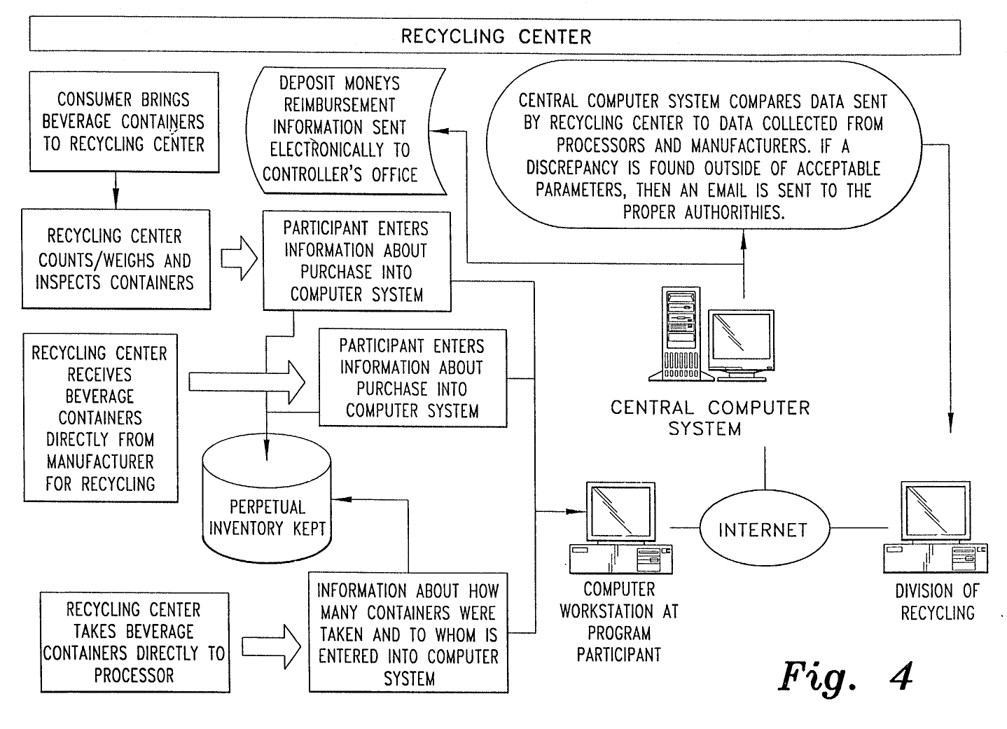

FIG. 5 is a flowchart of a preferred automated process for collection programs according to the present invention.

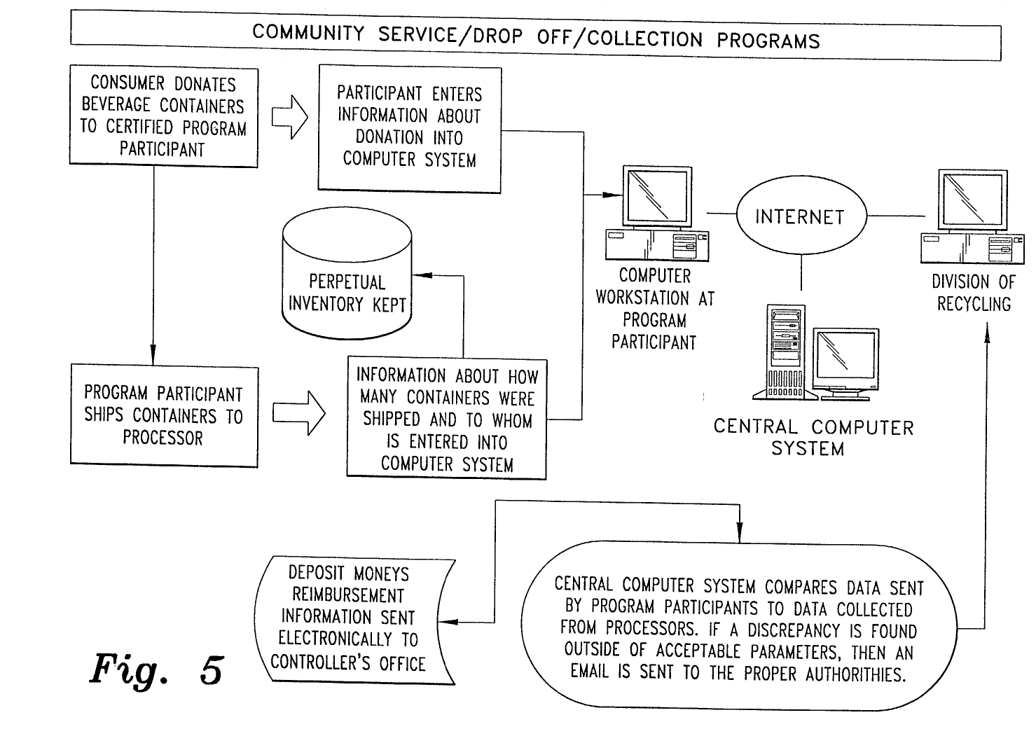

FIG. 6 is a flowchart of a preferred automated process for curbside collection programs according to the present invention.

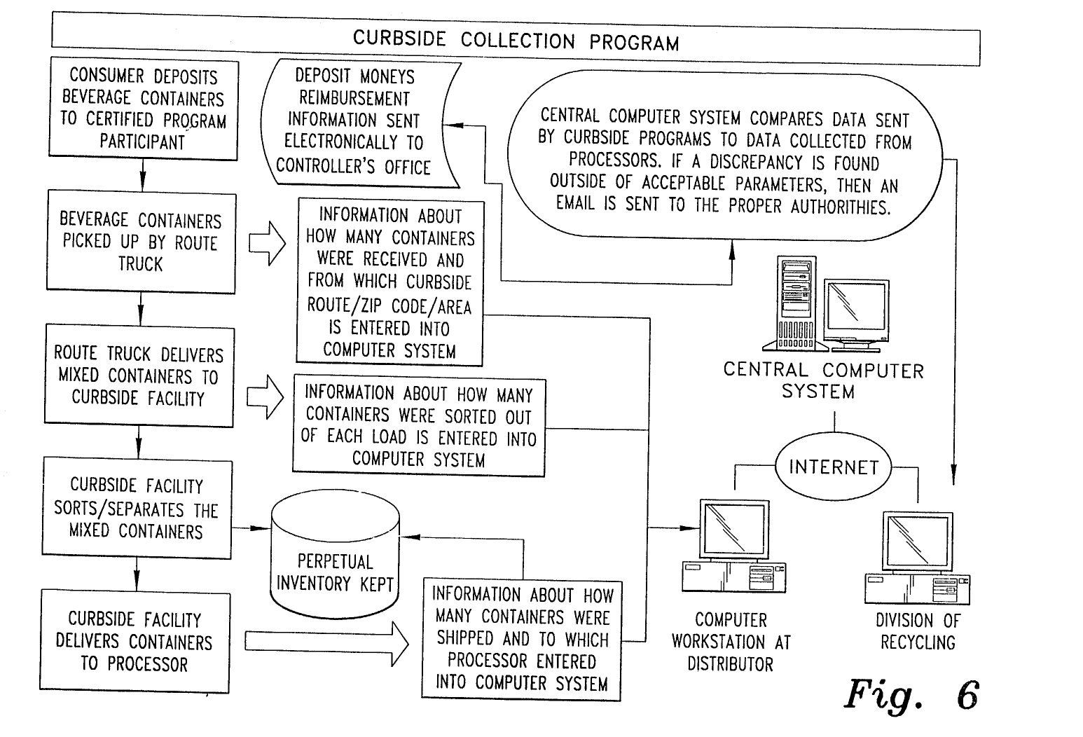

FIG. 7 is a flowchart of a preferred automated process for a beverage container end user according to the present invention.

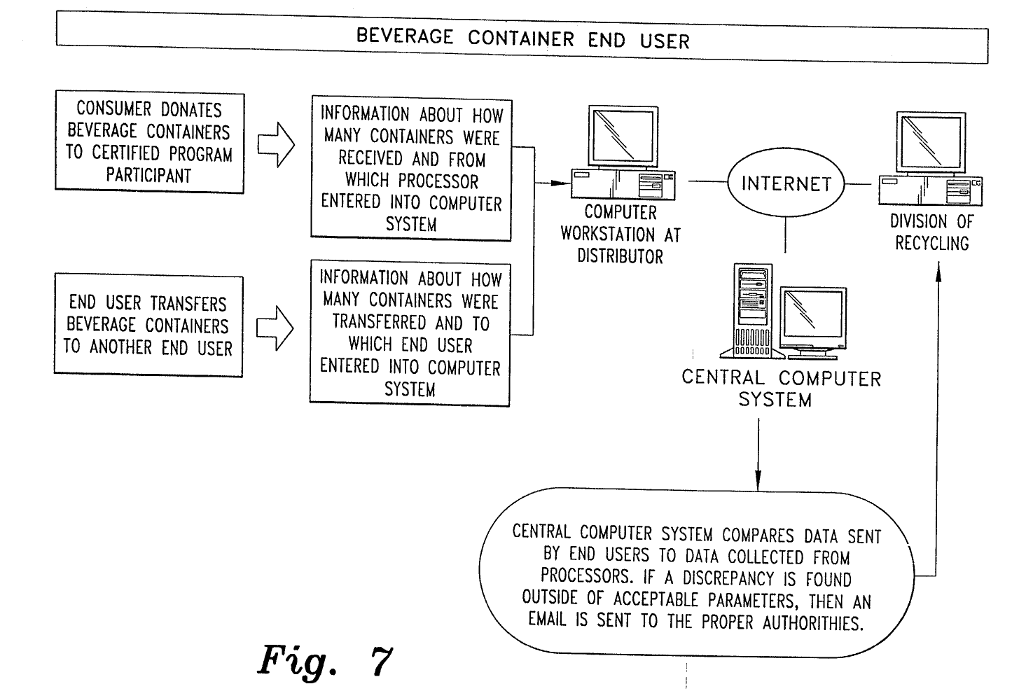

FIG. 8 is a flowchart of a preferred automated process for beverage container retailers according to the present invention.

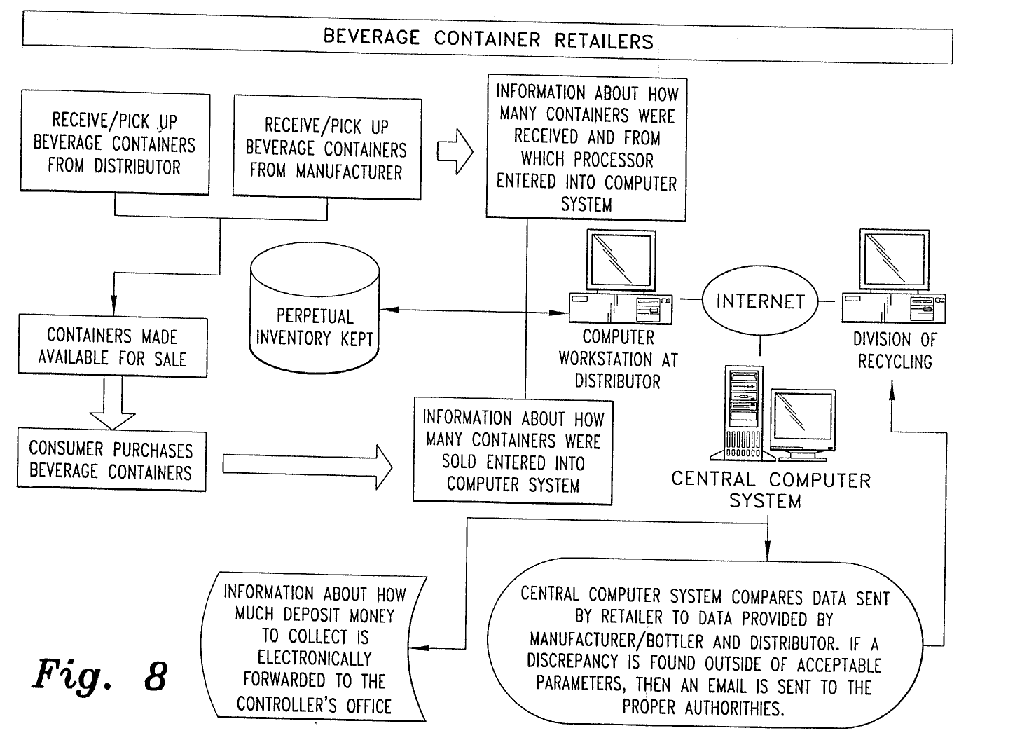

FIG. 9 is a flowchart of a preferred automated process for beverage container distributors according to the present invention.

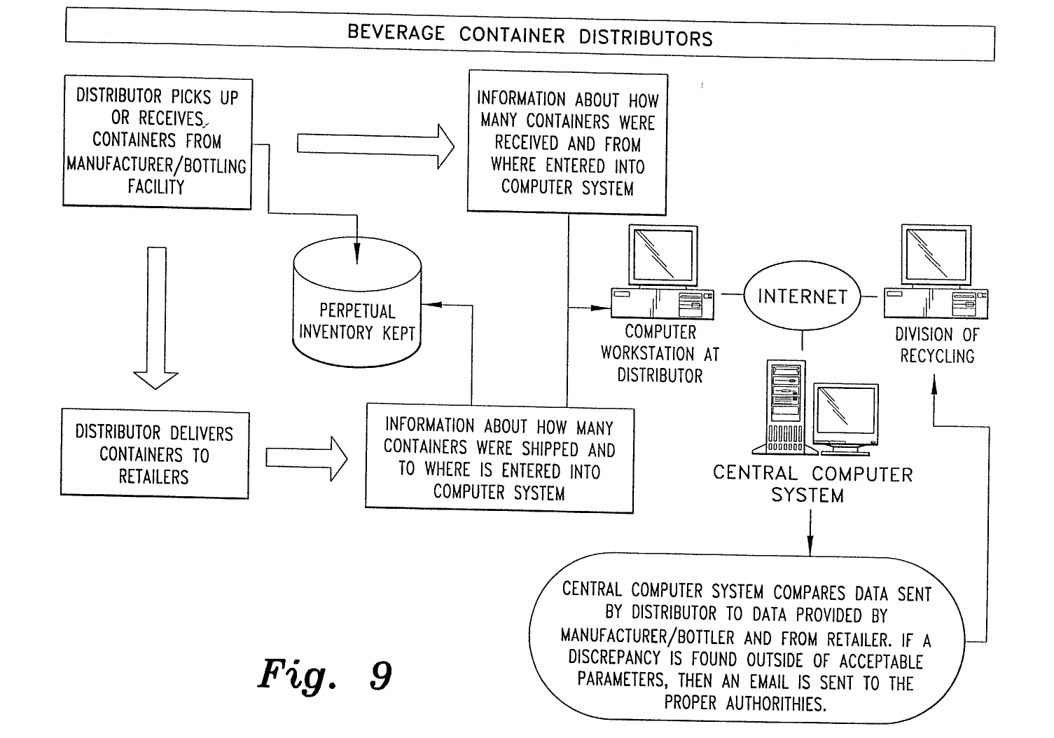

FIG. 10 is a flowchart of a preferred automated process for a bottling establishment.

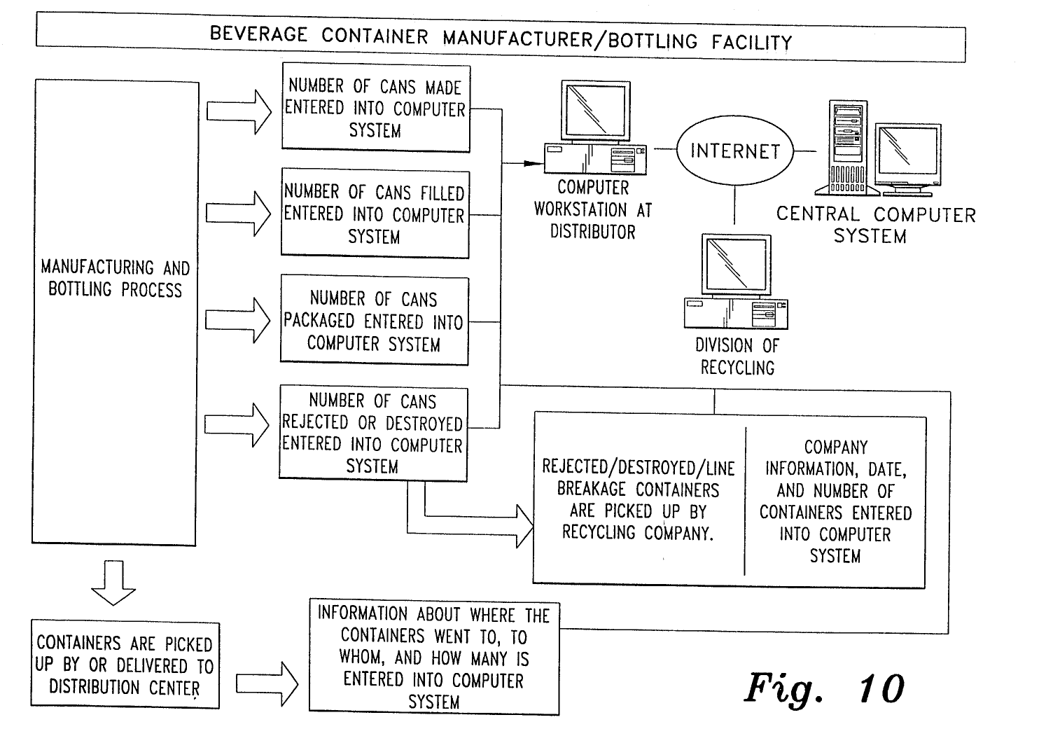

FIG. 11A is a flowchart of a first portion of a preferred automated process for a central computer system according to the present invention.

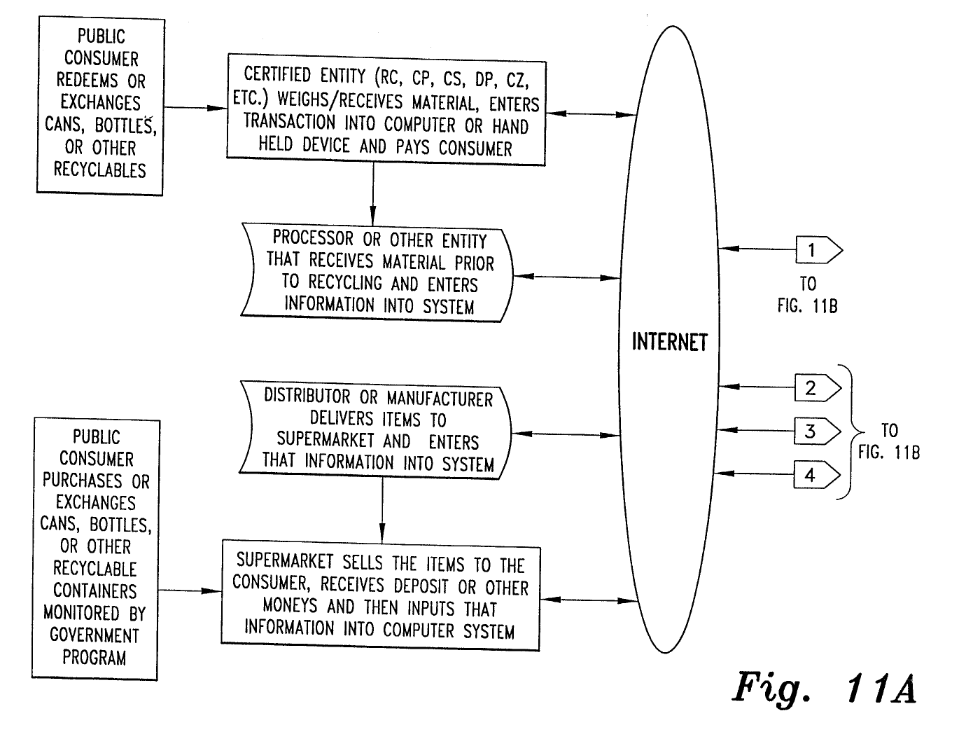

FIG. 11B is a flowchart of a second portion of a preferred automated process for a central computer system according to the present invention.

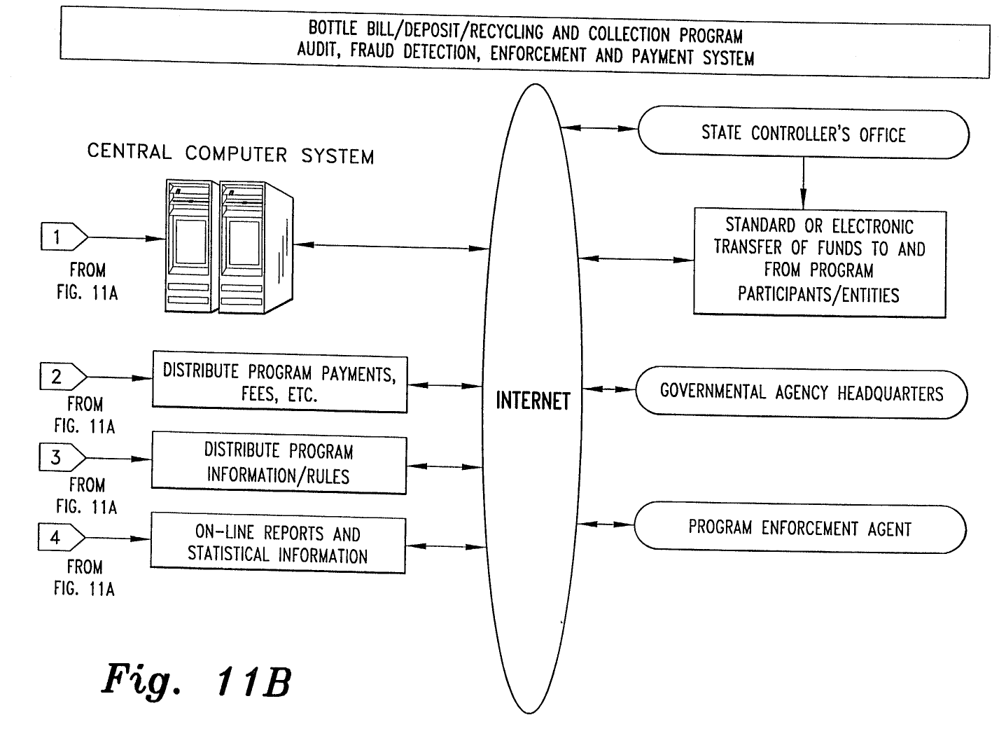

FIG. 12A is a flowchart of a first portion of a preferred automated process for monitoring pre-consumer beverage container movement according to the present invention.

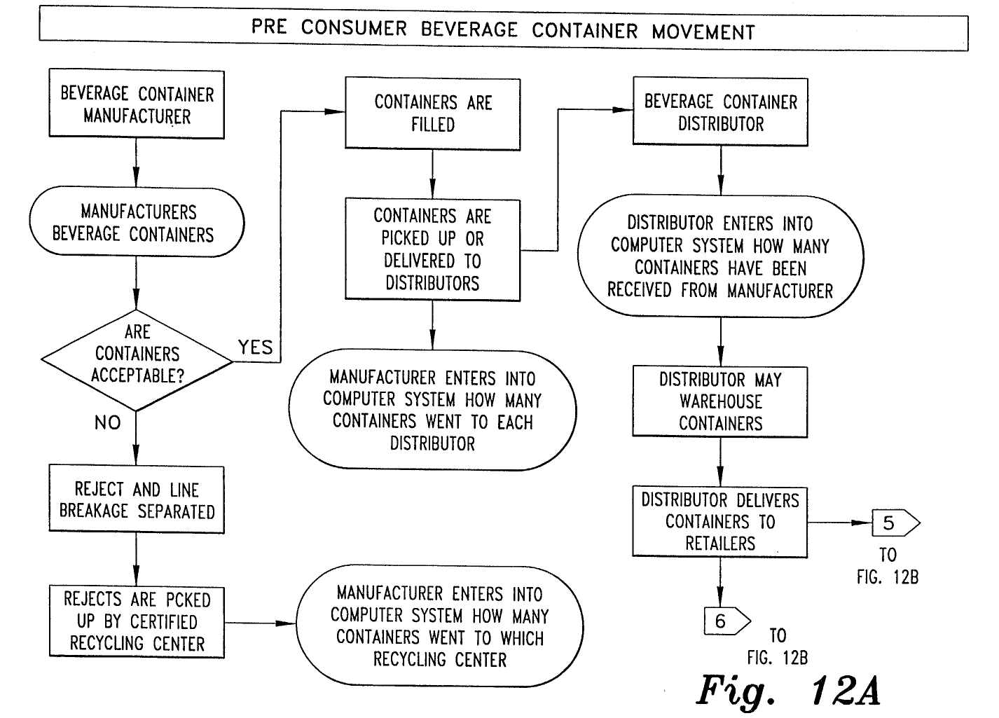

FIG. 12B is a flowchart of a second portion of a preferred automated process for monitoring pre-consumer beverage container movement according to the present invention.

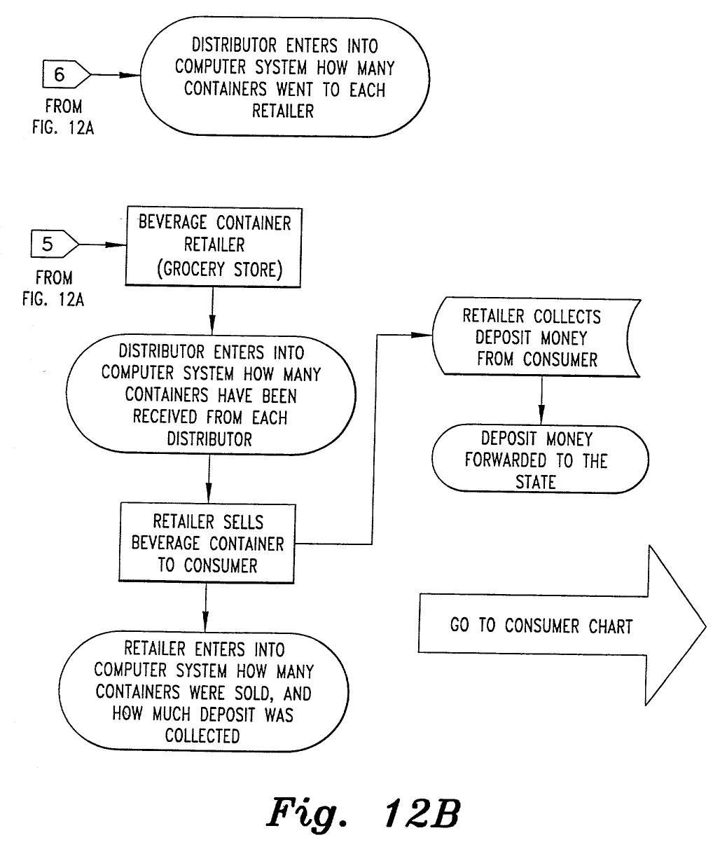

FIG. 13A is a flowchart of a first portion of a preferred automated process for monitoring post-consumer beverage container movement according to the present invention.

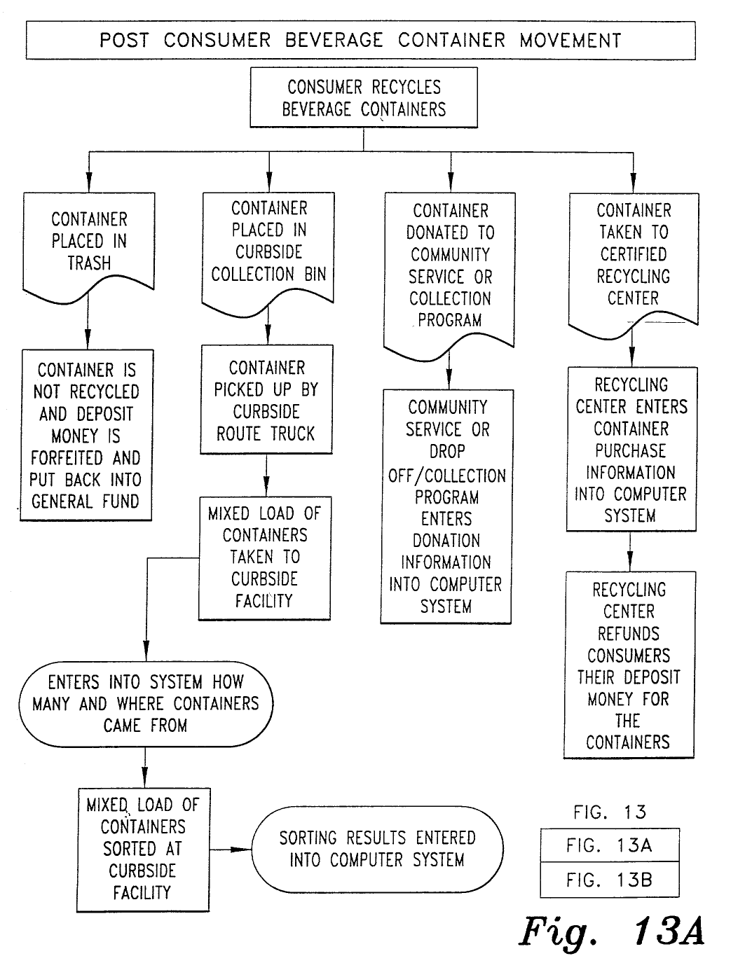

FIG. 13B is a flowchart of a second portion of a preferred automated process for monitoring post-consumer beverage container movement according to the present invention.

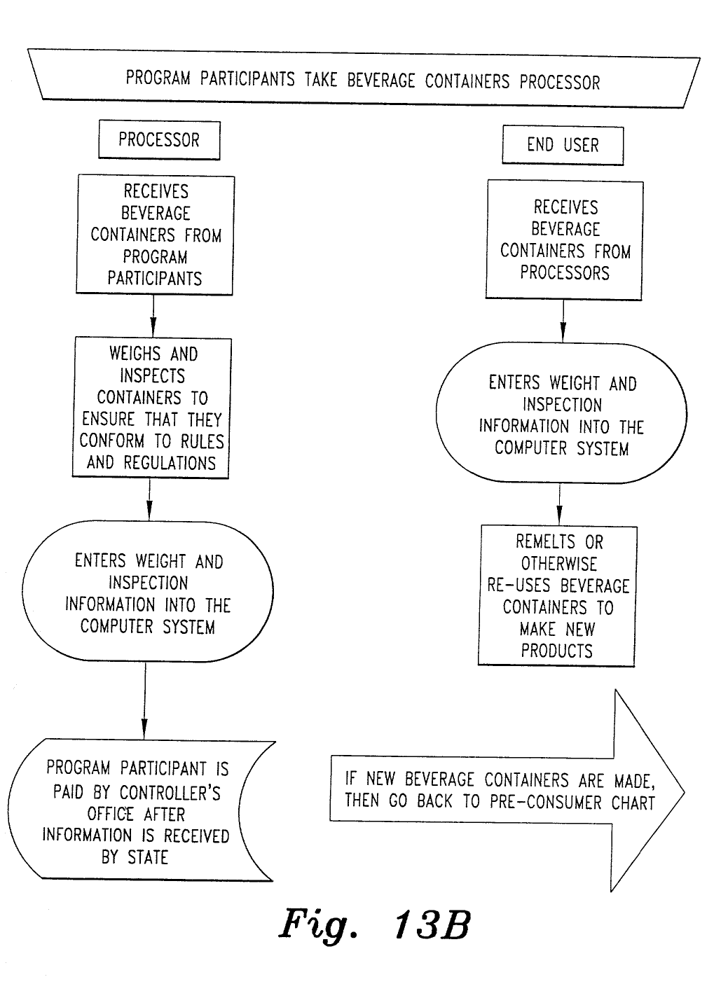

FIG. 14A is a flowchart of a first portion of a preferred automated process conforming to a current recycling protocol.

FIG. 14B is a flowchart of a second portion of a preferred automated process conforming to a current recycling protocol.

FIG. 14C is a flowchart of a third portion of a preferred automated process conforming to a current recycling protocol.

FIG. 14D is a flowchart of a fourth portion of a preferred automated process conforming to a current recycling protocol.

FIG. 14E is a flowchart of a fifth portion of a preferred automated process conforming to a current recycling protocol.

FIG. 14F is a flowchart of a sixth portion of a preferred automated process conforming to a current recycling protocol.

FIG. 14G is a flowchart of a seventh portion of a preferred automated process for current recycling protocol.

FIG. 14H is a flowchart of an eighth portion of a preferred automated process conforming to a current recycling protocol.

FIG. 14I is a flowchart of a ninth portion of a preferred automated process conforming to a current recycling protocol.

FIG. 14J is a flowchart of a tenth portion of a preferred automated process for current recycling protocol.

FIG. 14K is a flowchart of an eleventh portion of a preferred automated process conforming to a current recycling protocol.

FIG. 14L is a flowchart of a twelfth portion of a preferred automated process conforming to a current recycling protocol.

FIG. 14M is a flowchart of a thirteenth portion of a preferred automated process conforming to a current recycling protocol.

FIG. 15A is a flowchart of a first portion of a preferred automated process conforming to a proposed recycling protocol.

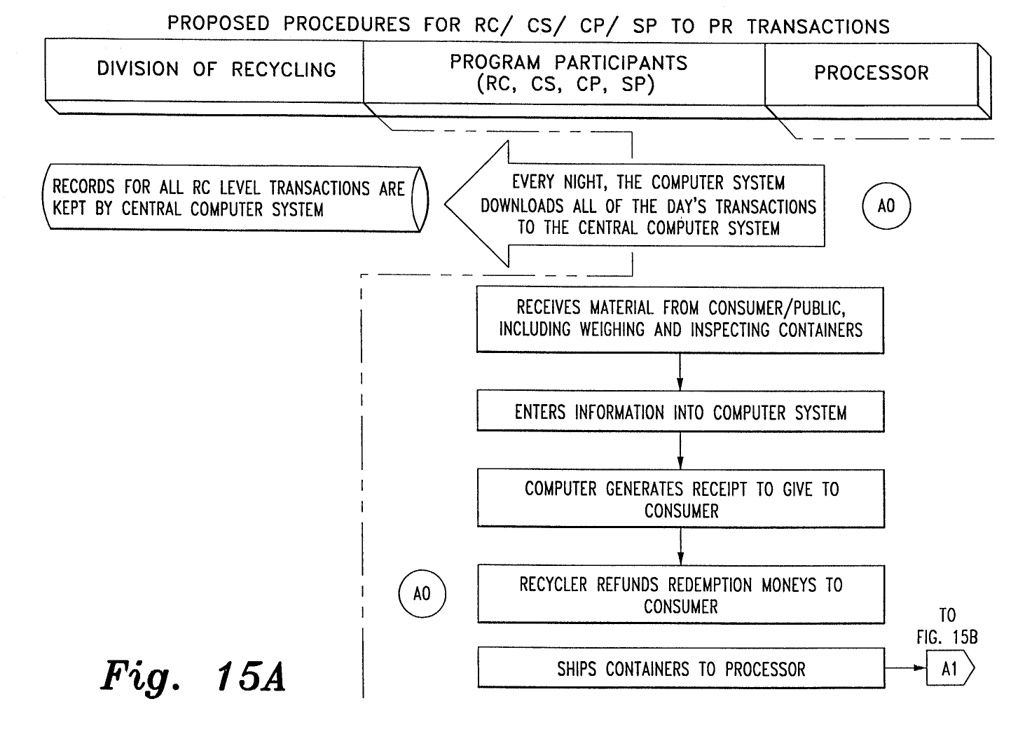

FIG. 15B is a flowchart of a second portion of a preferred automated process conforming to a proposed recycling protocol.

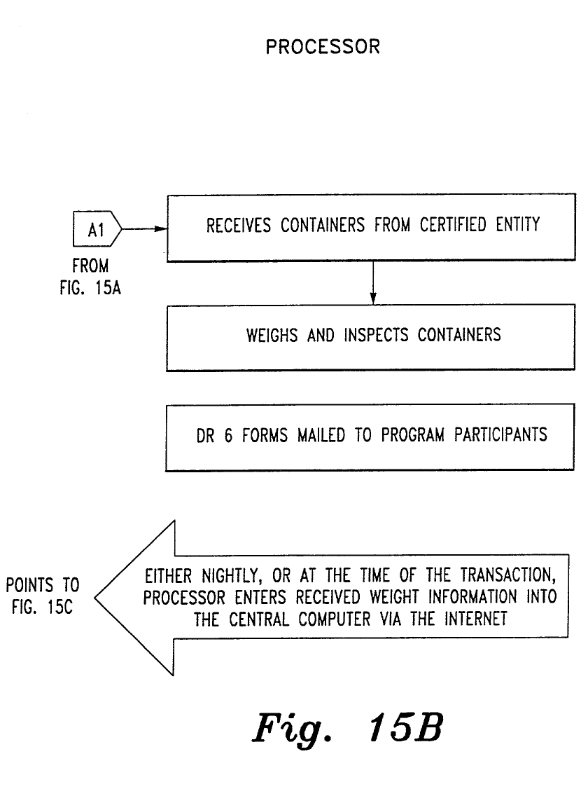

FIG. 15C is a flowchart of a third portion of a preferred automated process conforming to a proposed recycling protocol.

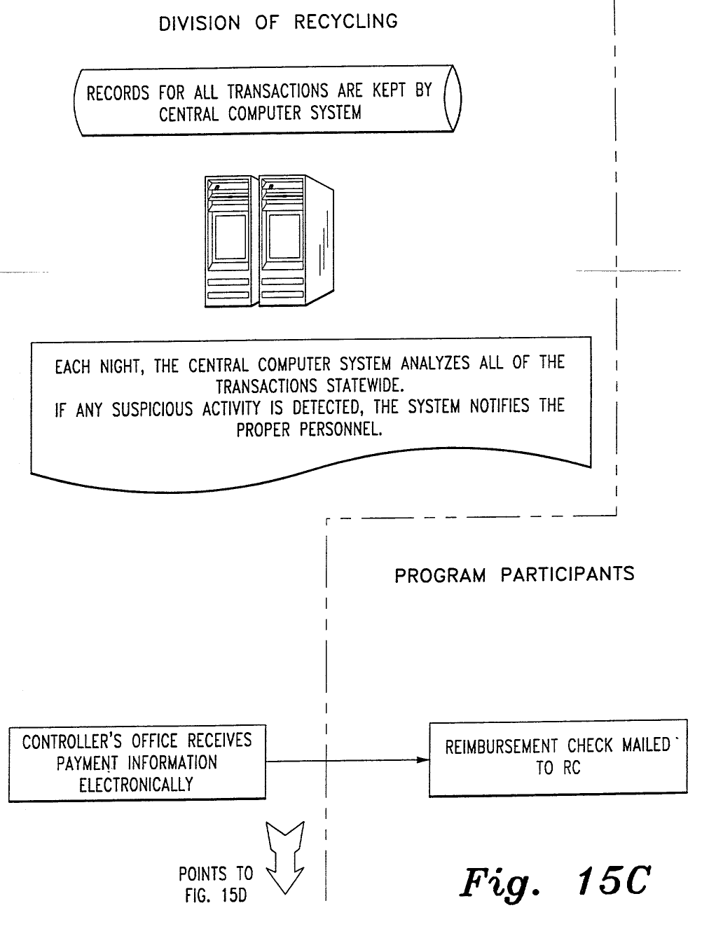

FIG. 15D is a flowchart of a fourth portion of a preferred automated process conforming to a proposed recycling protocol.

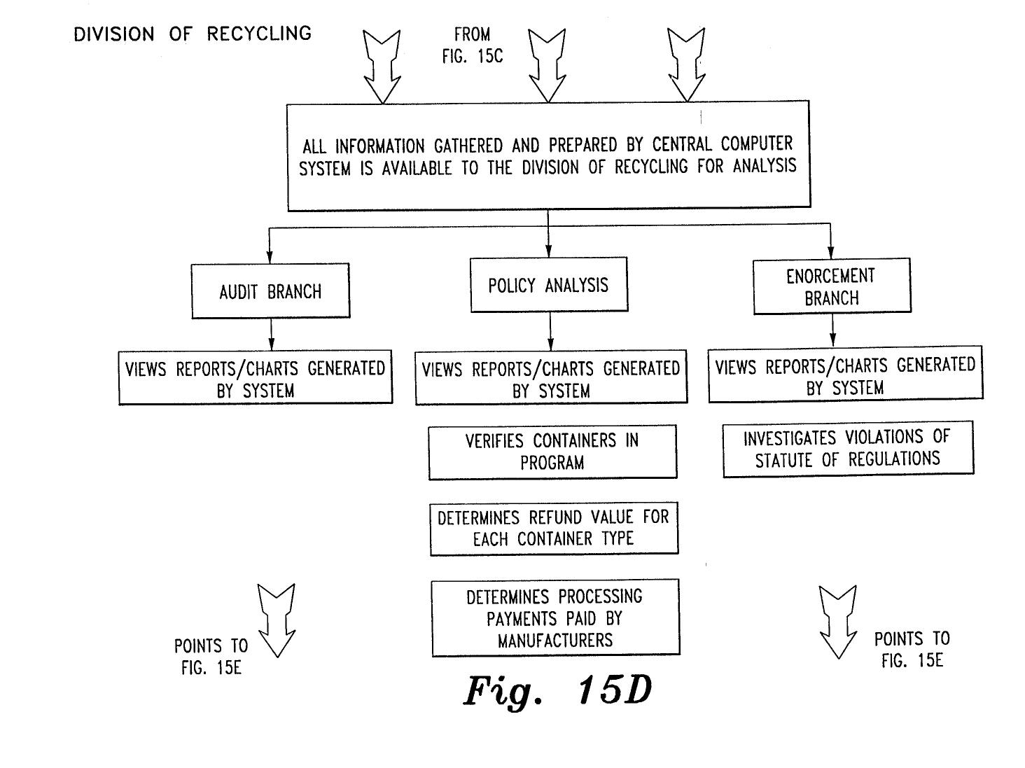

FIG. 15E is a flowchart of a fifth portion of a preferred automated process conforming to a proposed recycling protocol.

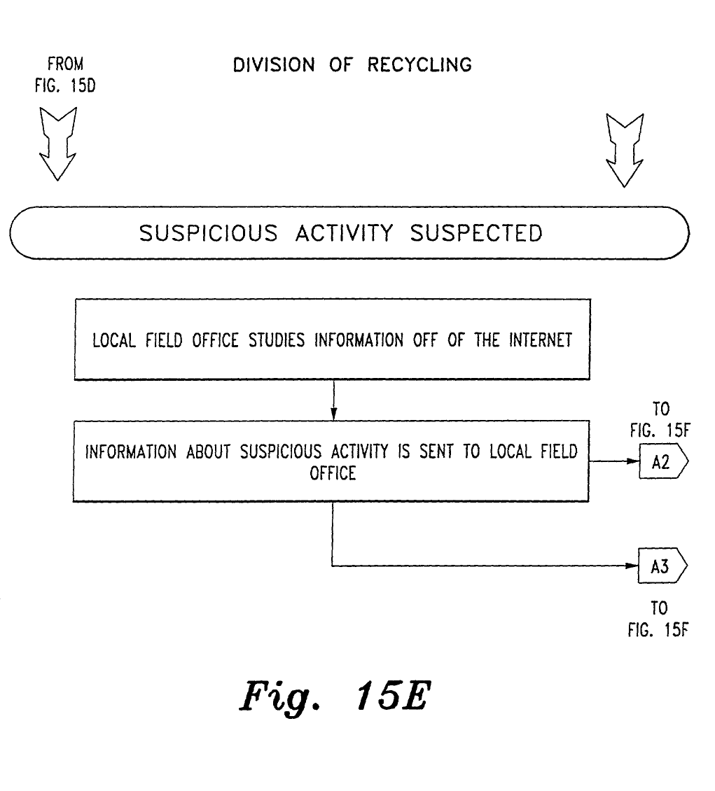

FIG. 15F is a flowchart of a sixth portion of a preferred automated process conforming to a proposed recycling protocol.

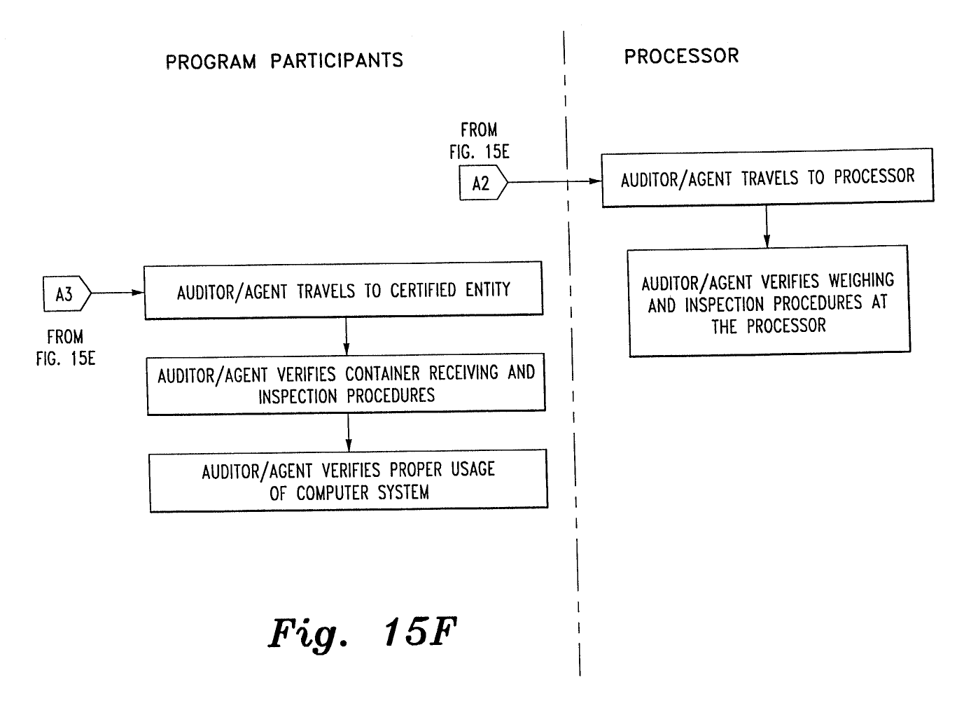

FIG. 15G is a flowchart of a seventh portion of a preferred automated process conforming to a proposed recycling protocol.

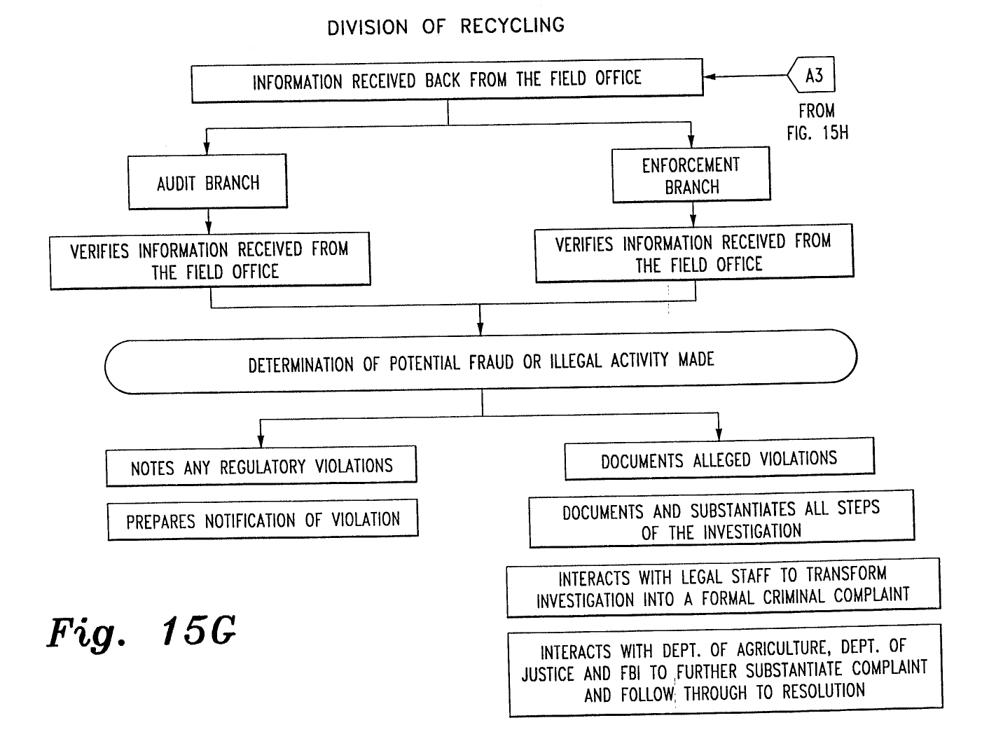

FIG. 15H is a flowchart of an eighth portion of a preferred automated process conforming to a proposed recycling protocol.

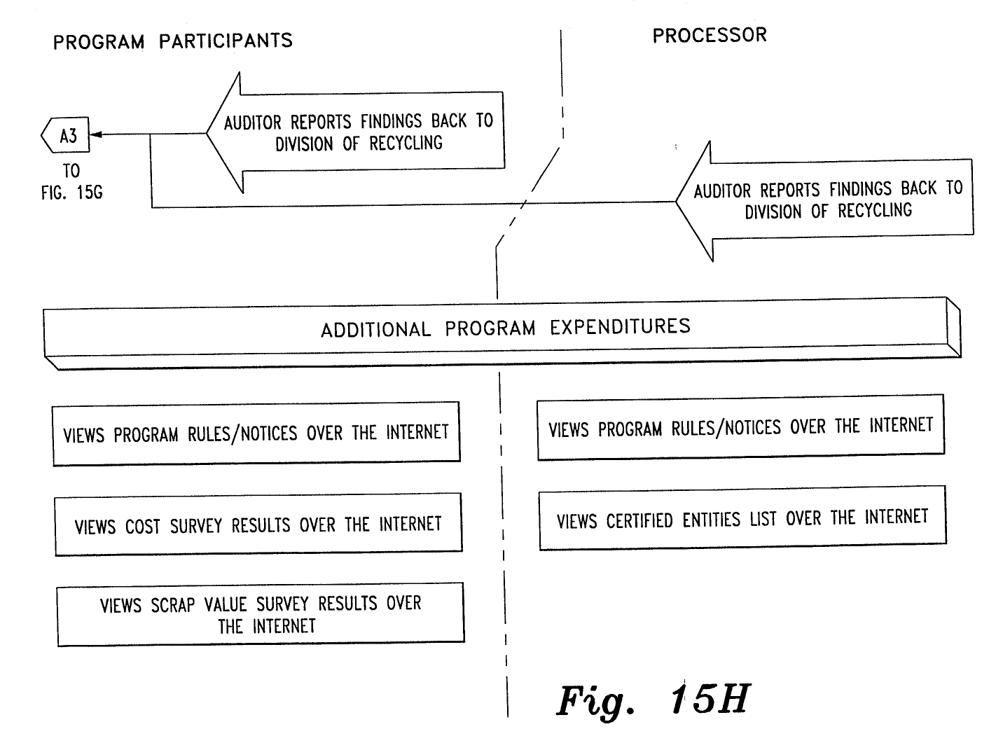

FIG. 15I is an illustration of a timeline applicable to the proposed recycling protocol.

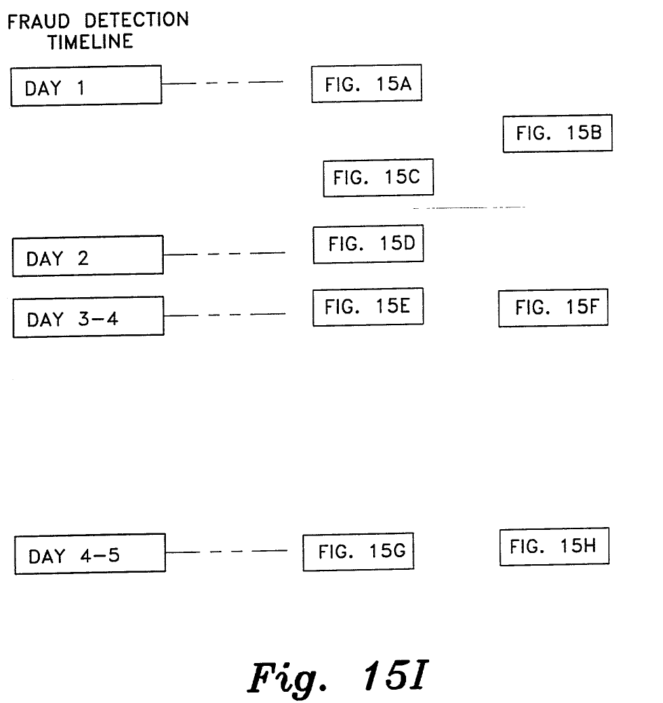

Similar reference characters denote corresponding features consistently throughout the attached drawings.

### DETAILED DESCRIPTION OF THE PREFERRED EMBODIMENTS

The present invention is an automated information processing system for collecting and analyzing transactional information relating to beverage container recycling. Although the instant system is described in relation to the California Division of Recycling's Container Deposit Program (a.k.a., California Redemption Value (CRV)), the system may be applied to other similar state programs for regulating beverage container deposits, waste abatement, litter reduction, and recycling.

The information processing system of the present invention uses a plurality of forward thinking algorithms for detecting suspicious or irregular recycling activity and alert proper authorities. In addition, the internet is used to link various program participants to a central computer system where the history of all transactions are stored.

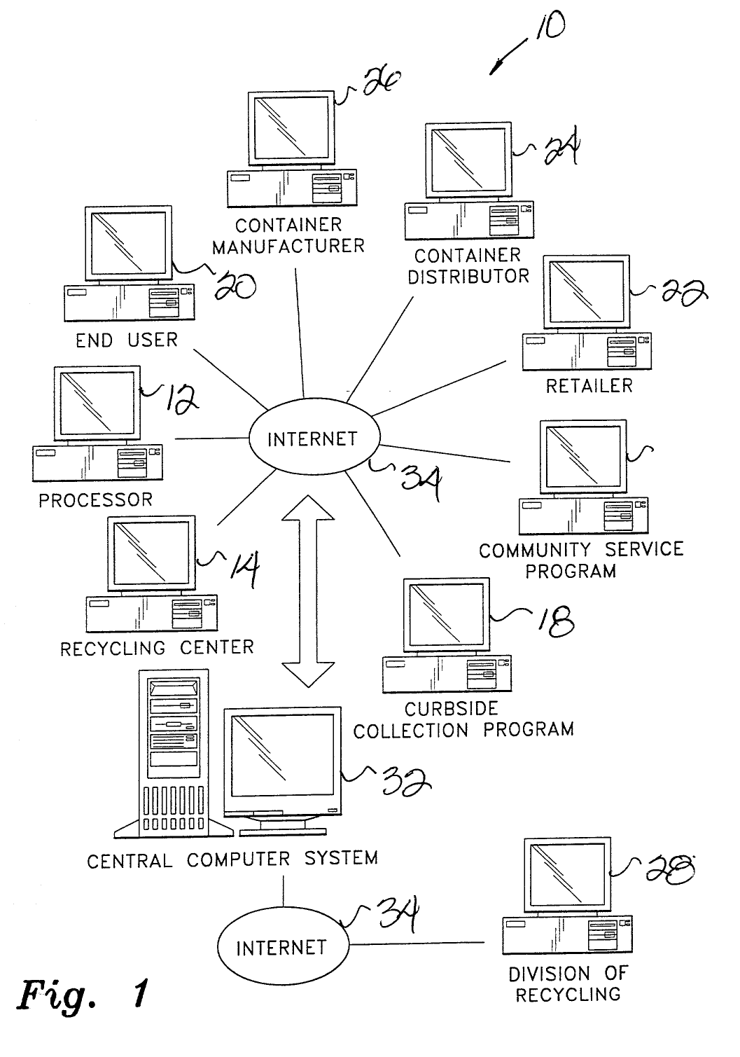

The Automated Information Processing System. A block diagram of a preferred automated information processing system 10 (hereafter referred to as the “processing system”) is shown in FIG. 1 according to the present invention. The processing system 10 includes a first client 12 (hereinafter referred to as the “processor program”, a second client 14 (hereinafter referred to as the “recycling center program”), a third client 16 (hereafter referred to as “collection program” or “community service program”), a fourth client 18 (hereafter referred to as a “curbside collection program” or a “curbside program”), a fifth client 20 (hereinafter referred to as a “beverage container end user program” or “end user program”), a sixth client 22 (hereinafter referred to as “beverage container retailer program” or “retailer program), a seventh client 24 (hereinafter referred to as “beverage container distributors program” or “container distributor program”), a eighth client 26 (hereinafter referred to as a “bottling establishment program” or “container manufacturer program”), an ninth client 28 (hereinafter referred to as a “governmental agency” program or the “Division of Recycling program”) , a server 32 (hereinafter referred to as a central computer system), and the Internet network 34. Each of the aforementioned clients is a conventional client communicatively linked by conventional communications means to the Internet network 34 for enabling each client to access services provided by the central computer system 30 (to be described later in this application).

The processor program 12 resides at a beverage container collection point (not shown) (hereinafter referred to as a “processor establishment”). There, the processor program 12 is specially programmed to process and manage recycling data and to send the recycling data to the server 32.

The processor establishment (not shown) is a facility where beverage containers are collected from various recycling program participants. The processor establishment (not shown) preferably has a scale for weighing beverage containers. The scale may be communicatively connected to the a computer workstation (to be discussed hereinafter in this application) by conventional communications means for enabling the weight information to be entered into a computer system.

The recycling center program 14 resides at a conventional certified recycling establishment (not shown), such as recycling facilities typically located behind supermarkets. The recycling center program 14 is specially programmed for recording how many containers are being redeemed (by a consumer) then calculating how much money should be refunded.

The community service program 16 resides at a conventional community service establishment (not shown) (e.g., a school, church, etc) The community service program 16 is specially programmed to record the quantity and weight of a beverage container donation then recording associated donation information into the computer system.

The curbside program 18 is a program that resides at a conventional curbside establishment (not shown), i.e., a non-profit or charity organization (e.g., a school, church, etc.). The curbside program 18 is specially designed for monitoring the influx of containers received by the curbside establishment (not shown). This information may then be used for auditing and inspection purposes to detect illegal activities.

The end user program 20 is a client program that resides at a conventional end user establishment (not shown). There, the end user program 20 is specially designed for monitoring the quantity of containers received by an end user's facility and for tracking movement of a container from one end user to another.

The beverage container retailer program 22 resides at a conventional retail establishment, such as a grocery or convenience store. The retailer program 22 is specially designed for totalling the amount of deposit money received from a consumer and forwarding that amount to the applicable state authority, e.g., the state of California.

The beverage container distributors program 24 resides at a conventional distributor establishment (not shown) for beverage containers. The container distributor program 24 is specially programmed for monitoring how many containers have been received and detecting any discrepancy between the quantity received by the distributor establishment (not shown) and the quantity shipped by a beverage container manufacturer.

The container manufacturer program 26 resides at a beverage container manufacturing establishment (not shown). The container manufacturer program 26 is specially programmed for periodically monitoring the quantity of containers manufactured, the quantity of containers sent to a particular distributor, and the quantity of containers that have been recycled during manufacturing.

The governmental agency program 28 is a computer program that resides within the server 32. The governmental agency program 28 is specially designed for producing reports, graphs, and charts from collected data and for providing tools for monitoring recycling activity.

The server 32 is a conventional program for providing services to other (client) programs. The server 32 is specially configured for collecting and storing data from each of the aforementioned client programs.

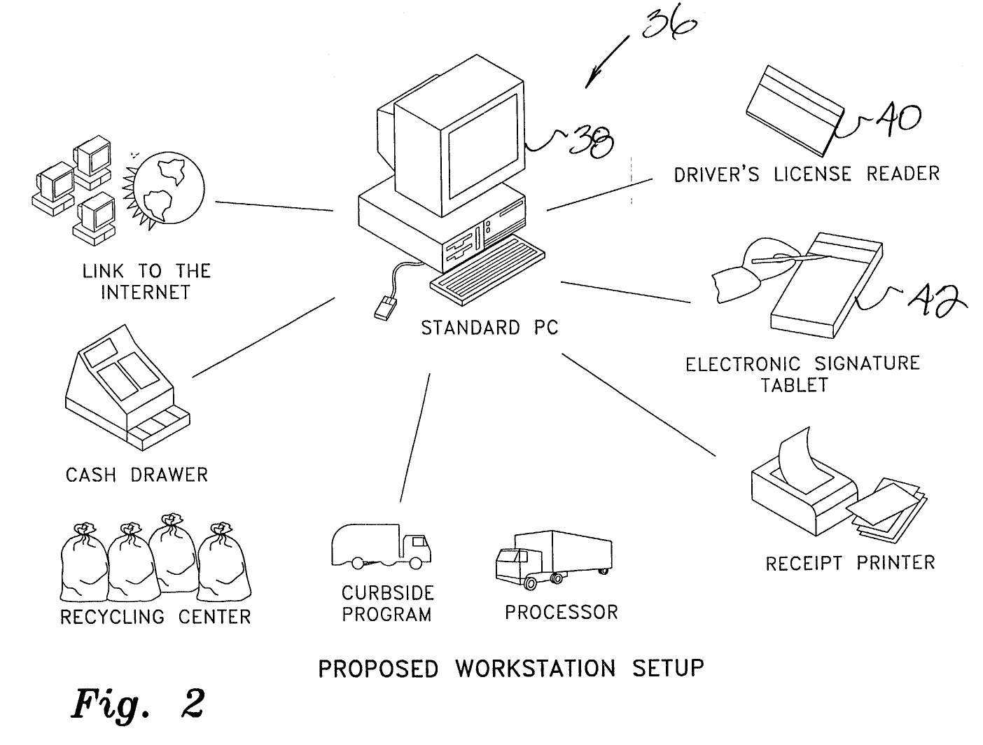

The Computer Work Station. Situated at each client is a computer work station for processing data from other related points of operation within the processing system 10. FIG. 2 shows a representative illustration of a computer work station 36 according to the present invention. The computer work station 36 preferably includes a conventional personal computer 38 (a.k.a., PC), a conventional hand-held device (not shown) (e.g., a palm pilot or cellular phone), and a conventional modem (not shown) or equivalent device for providing access to the internet.

Next, a preferred method for using the processing system 10 will be described.

Method of Use for Processor Program. When a program participant brings beverage containers to the processor establishment (not shown), the beverage containers may be weighed on a truck scale. The processor program 12 may cause the weight data to be transmitted electronically to the computer work station 36, where the weight data is processed. Alternatively, the weight data may be manually entered into the personal computer 38 by a computer operator.

The present invention anticipates two distinct embodiment of the method for using the processor program 12. A first embodiment defines a method of use designed around the current California Redemption Program. A second embodiment defines a method of use involving a streamlined variation of the current California Redemption Program. A description of each embodiment follows.

1. First Embodiment-Automated Process for the Current California Redemption Program. Constituents of the Processor Establishment (not shown) inspect the Beverage Containers to ensure that they conform to the California program rules and match what the Program Participant said they shipped. The constituents of the Processor Establishment (not shown) also have to confirm the calculations on the Shipping Report, DR 6. Our system is aware of all the program rules and processes the DR 6 shipping reports for the Processor. All they have to do is enter a few pieces of information from the DR 6. The system saves that information for later use in generating the DR 7.

After the DR 6 has been calculated, the Processor reimburses or pays the Program Participant for the Deposit monies they have either claimed or delivered, based on the Division of Recycling Rules for determining proper payment. Then, at regular intervals, the Processor generates a DR 7 for reimbursement. Because our system was used to receive all of the shipping reports, it makes creating the DR 7 form very easy. The DR 7 information is printed directly onto the DR 7 form and sent to the State of California for reimbursement.

2. Second Embodiment-Automated Process for a proposed California Redemption Program. When the Program Participant takes the Beverage Containers to the Processor Establishment (not shown), constituents of the Processor Establishment (not shown) inspect and weigh the material. That information is then entered into the computer workstation 36. Thereafter, the automated process takes over. More specifically, since Program Participant enter all transactions into the processor program 12, the need for paperwork between the Participant and the Processor is eliminated.

Moreover, since this information has already been sent to the Server 32 from the Participant, the Processor program 12 does not need to fill out or submit any paperwork for the State. The Central Computer System 32 will compare how much weight the Participant entered against how much the Processor program 12 entered. Based upon acceptable parameters as determined by the Division of Recycling, the Central Computer System 32 forwards payment information to the Controller's office, which in turn reimburses the Program Participant directly. This removes the burden of double checking a Participant's paperwork from the Processor program 12 as well as the financial burden of having to advance the Deposit moneys for 60 to 90 days before the moneys are reimbursed by the State.

Another benefit to eliminating the paperwork filed by the Processor program 12 is that the Processor program 12 is removed as a possible point of illegal activity. In the second mode of operation, the Processor program 12 does not handle or receive moneys related to the Deposit on Containers. With less entities handling money, there is less of a chance for illegalities.

At the Processors establishment (not shown), the containers may then be Canceled (i.e., the containers are no longer allowed to be sold as beverage containers).

If the Processor establishment (not shown) is not an end user, then constituents of the processor establishment (not shown) must take canceled containers to a processor establishment (not shown). When this occurs, the Processor weighs the shipment and enters that information into our system. The processor program 12 then compares the number of containers received by the establishment (not shown) to the number of containers shipped by the processor program. If the ratio is out of acceptable range, an email is sent to the proper authorities.

A Method of Use for Recycling Center Program. The following process is used when a consumer takes used beverage containers to a recycling establishment (not shown) (e.g., a recycling center behind a supermarket or a larger, more diversified recycling center containing metal or paper). The recycling establishment will contain a computer workstation 36 as previously described in this application. The computer workstation 36 adapted for performing various transactions relating to recycling of beverage containers. For example, by using a conventional driver's license reader 40, information may be obtained electronically from a consumer at the time of container redemption. Constituents of the recycling establishment (not shown) may enter a quantity or weight of beverage containers being redeemed. Thereafter, any deposit associated with the beverage containers may be refunded to the consumer.

When a consumer brings beverage containers to a recycling establishment (not shown), the consumer is usually paid a scrap value for the material as well as for the deposit. The amount of scrap value paid by the recycling center is monitored by the Division of Recycling program 28. Currently, the Division of Recycling requires program participants to fill out a survey detailing this information, is then tabulated. By contrast, the recycling center program 14 will automatically collect the tabulated information as part of this process, thereby eliminating any need for the Division of Recycling to conduct such a survey.

Another aspect of how the recycling center program 14 may streamline the current California Redemption Program is through detection of “Predatory Pricing”. Predatory Pricing occurs when a recycling center pays a price substantially higher then its competition. Such tactics may result in putting a competitor out of business. “Predatory Pricing” has been deemed to be illegal by the Division of Recycling. Practically speaking, the only way that the Division of Recycling learns of such practices is when recycling centers call up to complain. By virtue of being hooked to all recycling centers and monitoring all transactions, the server 32 analyze the data on a nightly basis for occurrences of predatory practices. If a recycling establishment (not shown) is found to be paying for containers at a price substantially above the conventional pricing in a particular vicinity, the central computer system 32 will send an email to appropriate authorities.

At the time a recycling establishment (not shown) receives containers, the recycling center program 14 has the ability to handle this step in two different ways. In a first mode, the recycling center program 14 executes electronically all of the processing steps currently being handled via paper documents. Alternatively, in a second mode, the recycling center program 14 can implement a streamlined protocol that simplifies the current paper laden process, thereby achieving the same end result more efficiently.

In the first mode, the recycling center program 14 is able to generate a recycling center shipping report from receipts generated by the consumer purchases. The shipping report can be generated quickly, easily, and accurately, allowing a user to select which receipts to use for shipment. The recycling center program 14 is designed to print shipping reports directly onto a State required form. The recycling center program 14 is also designed to generate daily summary reports, 250lb Information reports, and DR 6 Shipper breakdown reports, detailing all of the tickets attached to a particular shipment.

In the second mode, the recycling center program 14 can eliminate the DR 6 report. Because the recycling center program 14 enters all transactions into the information processing system 10, users of the recycling center program 14 will know how many of each type of container the recycling center establishment should have. Then, when constituents of the recycling establishment (not shown) ship containers to the processor establishment (not shown), the processor program 12 can enter the weight received. With this information, the recycling center program compares the weight received to the quantity of containers the recycling center has purchased. If the ratio is out of acceptable parameters, the recycling center program 14 notifies the proper authorities via email. By eliminating the DR 6, the recycling center program 14 saves the Division of Recycling printing, mailing, processing, handling and storage costs.

By monitoring all of the transaction coming into and the shipments out of a recycling establishment (not shown), the recycling center program 14 will be able to keep a perpetual inventory of containers at the recycling establishment (not shown). This information can be used during audits and inspections to determine if the recycling establishment (not shown) is engaging in possibly illegal activities.

Method of Use for Community Service Program. Community service and drop-off sites are certified entities that are usually associated with a non-profit or charity organization, such as a school, church, etc. When the consumer brings their beverage containers to one of these Program Participants, the consumer is essentially “donating” the beverage container to that participant. As consumers donate their beverage containers, the containers are counted or weighed and the donation information entered into the community service program.

When the program participant takes the containers to a processor establishment (not shown), a constituent of the processor establishment (not shown) enters in how many containers they received into the processor establishment (not shown). The community service program 16 compares this information to the quantity of containers that have been received. If the ratio exceeds acceptable limits, the an email is sent to notify the proper authorities. By monitoring all of the transaction coming into and the shipments out of the community service establishment (not shown), the community service program is able to keep a continuous inventory of containers at the establishment. This information can be used during audits and inspections to determine if constituents of the community service establishment (not shown) are engaging in illegal activities.

Method of Use for Curbside Collection Program. Disposal of beverage containers is accomplished by placing the containers in a curbside collection program recycling bin. On a regular basis, the curbside bins are collected and consolidated into trucks. The trucks may then take the containers to a central establishment for separating and sorting the containers. Constituents of a curbside collection program may then take the separated containers to processor establishment where deposit money is paid for the containers.

The curbside collection program 18 carries out its function through a variety of steps. First, the curbside collection program 18 may be communicatively connected to the truck scale, for enabling the curbside collection program 18 to monitor all incoming truck loads of mixed containers. Accordingly, the curbside collection program 18 is able to avoid manual entry of weights. Alternatively, the curbside collection program 18 may be configured as a standalone system requiring manual entry of any weight information associated with beverage containers. Accordingly, each truck is weighed and the location of the origin of the containers is entered in the curbside collection program 18. The curbside program 18 then enters how many of each type of container have been sorted out of the mixed container loads. This information is tied to the location where the containers came from, which may then be compared to how many containers were distributed and sold in that area. If excessive discrepancies are found, the curbside collection program 18 reports these discrepancies to appropriate authorities via email further investigate the matter.

When the curbside program 18 is ready to recycle or ship containers to a processor establishment (not shown), the containers get weighed prior to shipment. This information is then entered into the curbside program 18. The shipment is then received by the Processor who weighs the containers and enters that information into our computer system via the Workstation at their facility. The information is then compared and if there is a discrepancy, the proper authorities are notified via email.

By monitoring the trucks coming into and out of the Curbside Program, the system will be able to keep a perpetual inventory of Containers at the Curbside establishment. This information can be used during audits and inspections to determine if the Curbside Program is engaging in possibly illegal activities.

Method of Use for End User Program. When an end user receives containers from the processor establishment, the end user enters the weight of the containers into the associated computer workstation 36. The personal computer 38 double checks the weight against the weight recorded by the processor program 12. If ratio in weight values exceeds a predefined range of acceptability, an email is sent to the proper authorities.

In addition to monitoring how many containers go into an end user's establishment (not shown), the end user program 20 tracks containers being transferred from one End User to another. This helps to prevent Beverage Containers from getting out of the mill and illegally ending up back into the California Redemption Program.

Currently, the California Division of Recycling does not monitor activity at end user facilities. Like the container manufacturers, the Applicant believes that all program participants must be carefully monitored to eliminate illegal activity. However, the present invention does not require the end user to be monitored. The automated information processing system 10 will work effectively even if it simply monitors the entities currently being monitored by the Division of Recycling.

Method of Use for Retailer Program. A retailer (e.g., a grocery or convenience store) has the primary responsibility for collecting deposit money from a consumer and forwarding the money to the State of California. When a retailer receives a shipment of beverage containers from a distributor or manufacturer, the retailer enters the number of containers into the retailer program 22. This information is compared against the information entered by the distributor and the manufacturer. If a discrepancy is found, proper authorities are notified via email.

Next, a consumer goes to a retailer and purchases a beverage container that is part of the California Redemption Program. In addition to the price of the beverage, the retailer collects a monetary deposit from the consumer. After a specified period of time, the retailer reports how many containers it has sold as well as how much money has been deposited into the retailer's possession. The central computer system 32 takes this information and generates statistics on how many containers are being purchased and where. This information will later be used to compare against how many containers have been redeemed in a specific area.

After a consumer has finished a beverage, that consumer has number of options regarding future use of the container. One option is that the consumer dispose of the container by placing it in the trash. If a container is placed in the trash, it is very unlikely that the container will be recycled. In that event, the consumer loses its deposit money which remains with the Division of Recycling's general fund to eventually be used for other purposes.

Method of Use for Container Distributor Program. From a manufacturer, the beverage containers are delivered to or picked up by distributors. Thereafter, the distributors warehouse then distribute the beverage containers to local supermarkets or grocery stores. When the distributor picks up containers from a manufacturer, the distributor enters the quantity of containers received into the distributor program 24. This serves as a double check against the number of containers shipped by the manufacturer. If there is a discrepancy, the proper authorities are notified via email.

When a distributor delivers containers to a retail outlet, the quantity of beverage containers delivered is entered into the distributor program 24. This information, coupled with the number of containers picked up from the manufacturer provides a means for continuously estimating inventory. If the distributor has delivered more containers than the quantity received, then the distributor program 24 notifies appropriate authorities. In addition, the distribution program 24 records the quantity of beverage containers taken to a retail establishment, thereby enabling the distributor program 24 to determine the number of beverage containers delivered to any given area, along with its associated zip code, city, county, etc. This information is important to detecting if any suspicious activity is occurring, and where.

Method of Use for Container Manufacturer Program. If a beverage container manufacturer is manufacturing containers for the State of California, then the number of containers that it makes is vital to understanding what goes on within the state and its associated redemption program as a whole. At the end of a specified period of time, a manufacturer will electronically report on a quantity of containers manufactured, a quantity of containers sent each distributor, and a quantity of containers destroyed or recycled during the manufacturing process, including the quantity attributable to each program participant. By recording the number of containers manufacturer in a particular state, an upper limit is placed on the number of containers that can be redeemed.

By monitoring who a manufacturer sends rejected and broken containers to for recycling, the situation of containers ending up back into in a redemption program and being illegally redeemed may be avoided. This result may be achieved by monitoring how many containers a recycling establishment (not shown) receives from a manufacturer, the public, or other recycling facilities and the quantity of containers shipped or “cancelled.” The term “cancel” refers to the process of rendering beverage containers unrecognizable as beverage containers. This can be done by shredding, re-melting, bailing, compressing, or other equivalent means.

Currently, the California Program does not monitor the activity of container manufacturers. Lack of monitoring of manufacturer. Lack of manufacturer monitoring increases the possibility of fraudulent or illegal activity. Without monitoring a bottle bill program, the detection of fraud or other illegal activity becomes extremely difficult, if not impossible. The container manufacturer program 26 is designed in two ways. Preferably, the container manufacturer program 26 monitors the activities of container manufacturers. However, an alternative approach is to monitor other facets of the Bottle Bill Program excluding manufacturers.

Method of Use for Governmental Agency Program. With all of the information being downloaded daily into the Server 32, constituents of the Division of Recycling (or other governmental agency that overseas a state's waste management laws) can track all information and activity throughout the State of California via the governmental agency program 28. These constituents can access the governmental agency program 28 via the Internet through HTTP requests or via a “Terminal Server” type setup. In addition to the fraud detection reports, discussed earlier, the governmental agency program 28 will provide constituents of a governmental agency with activity and history reports. These reports will be available for and selectable by program participant, public customer name, public customer driver's license, container type, zip code, distribution center, retailer, date range, manufacturer, end user. Constituents of a governmental agency also view charts detailing such activity and providing comparative analysis of program participants and overall average performance data.

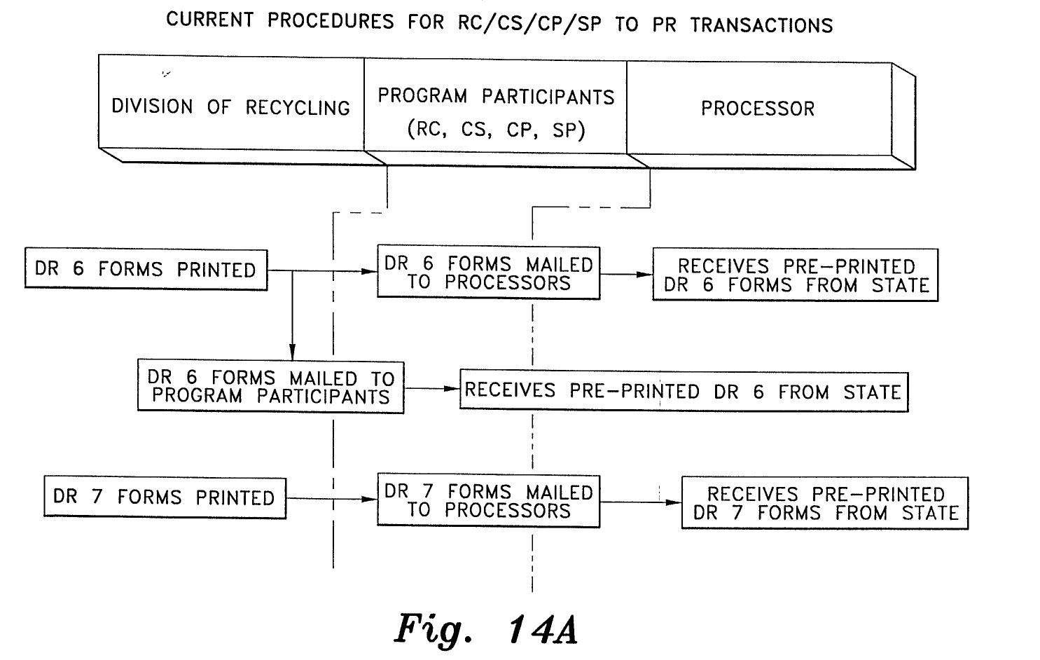

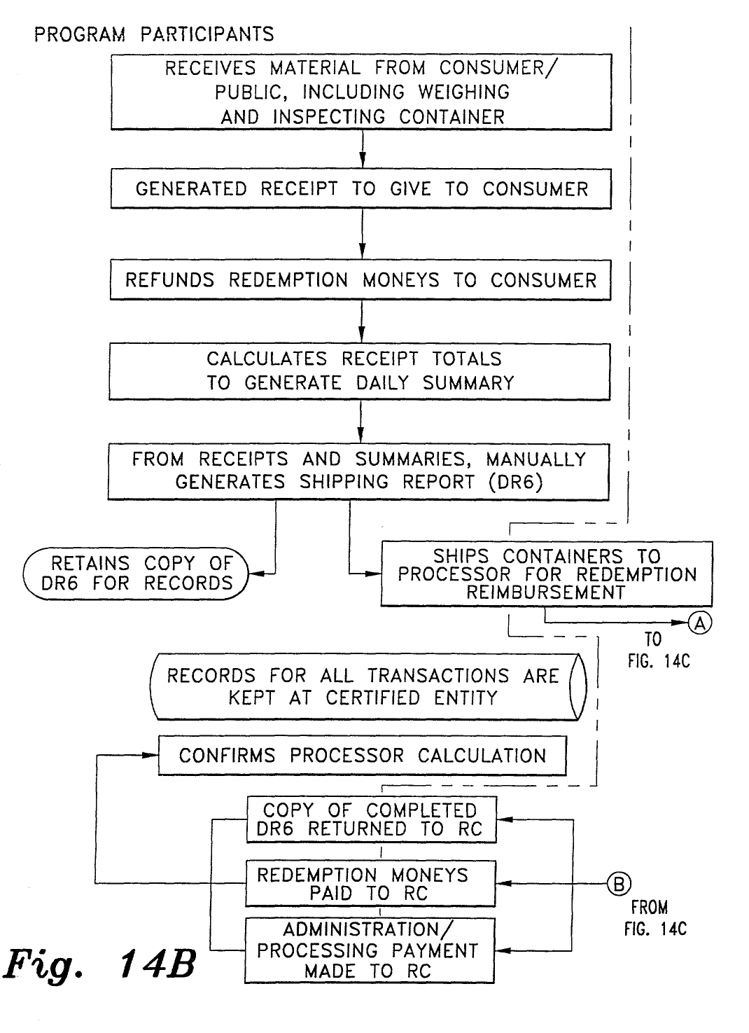

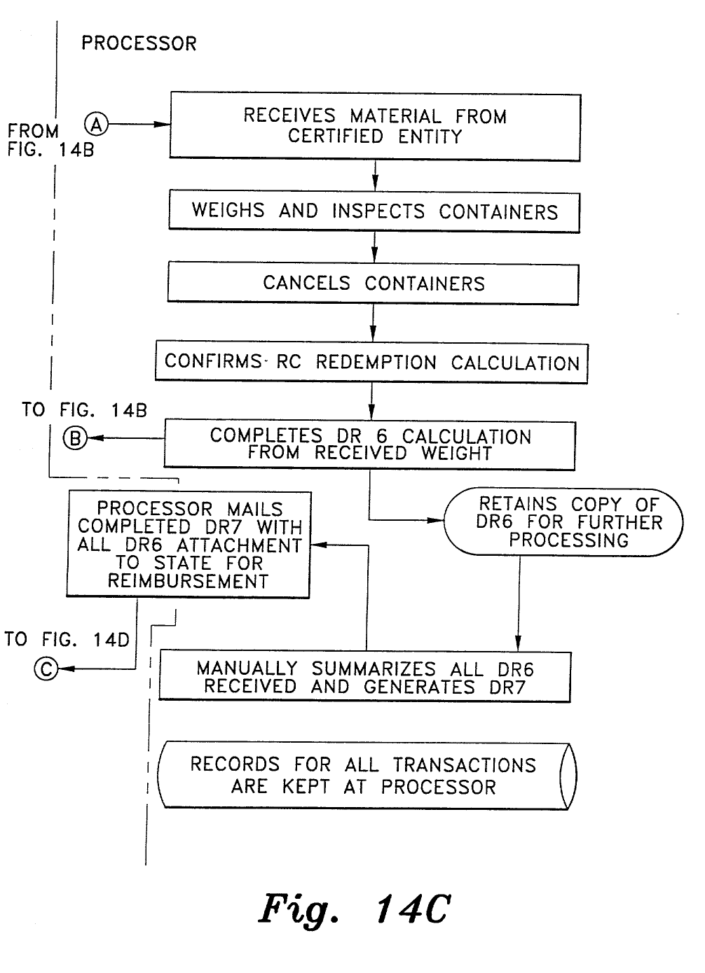

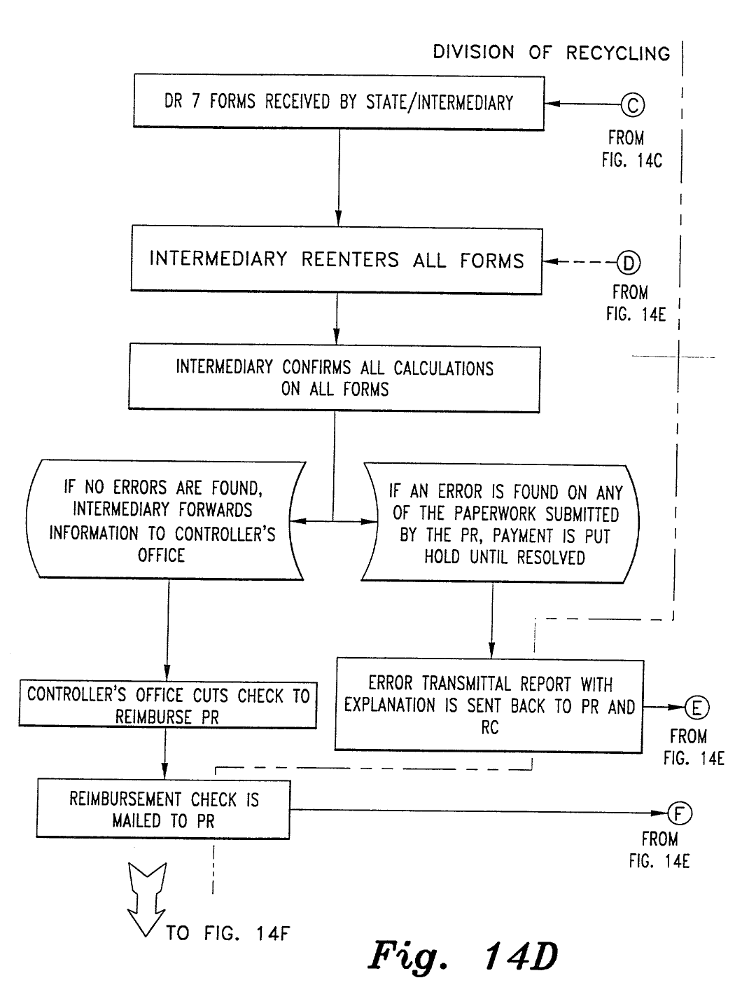

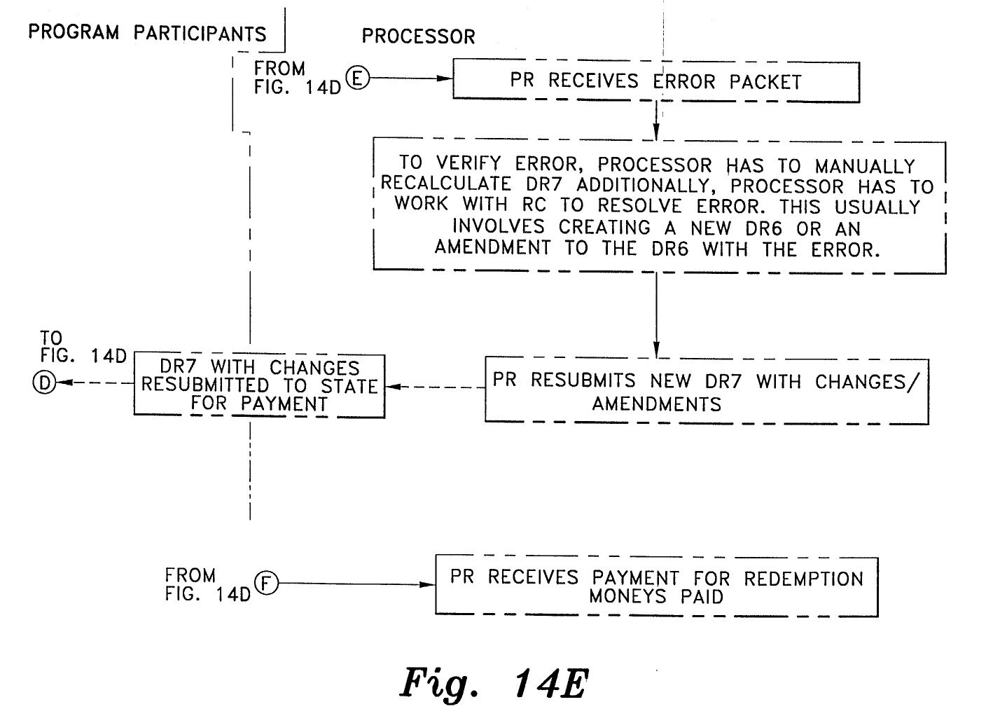

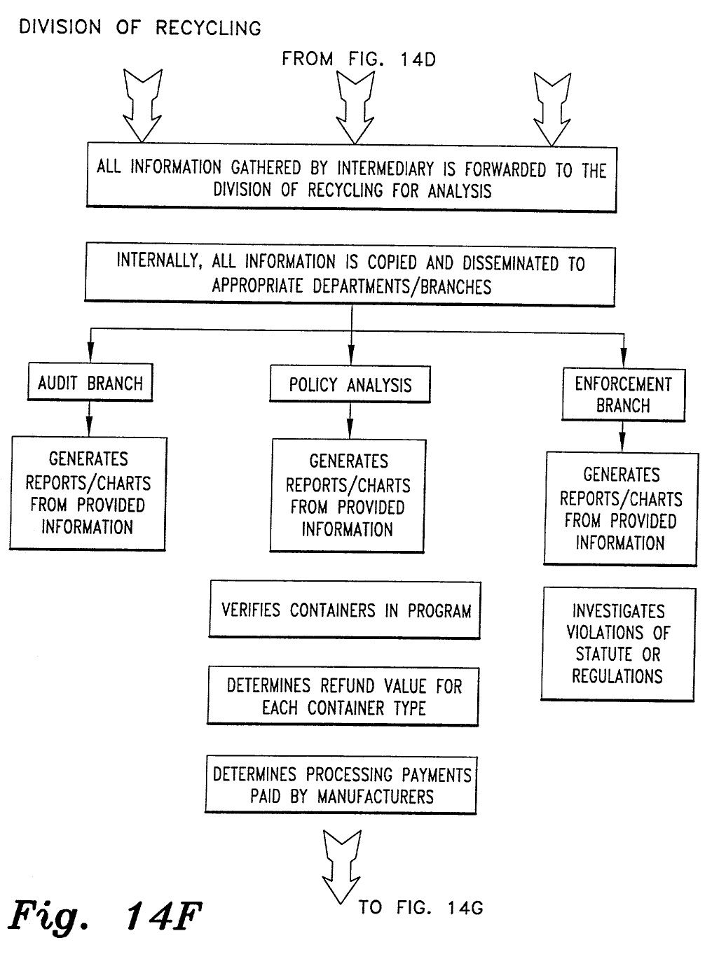

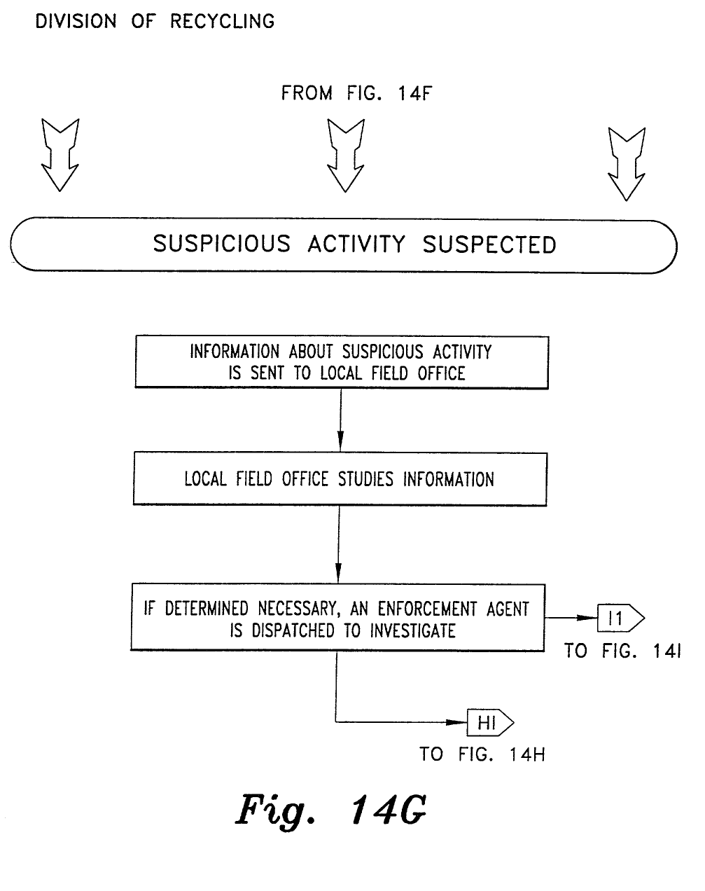

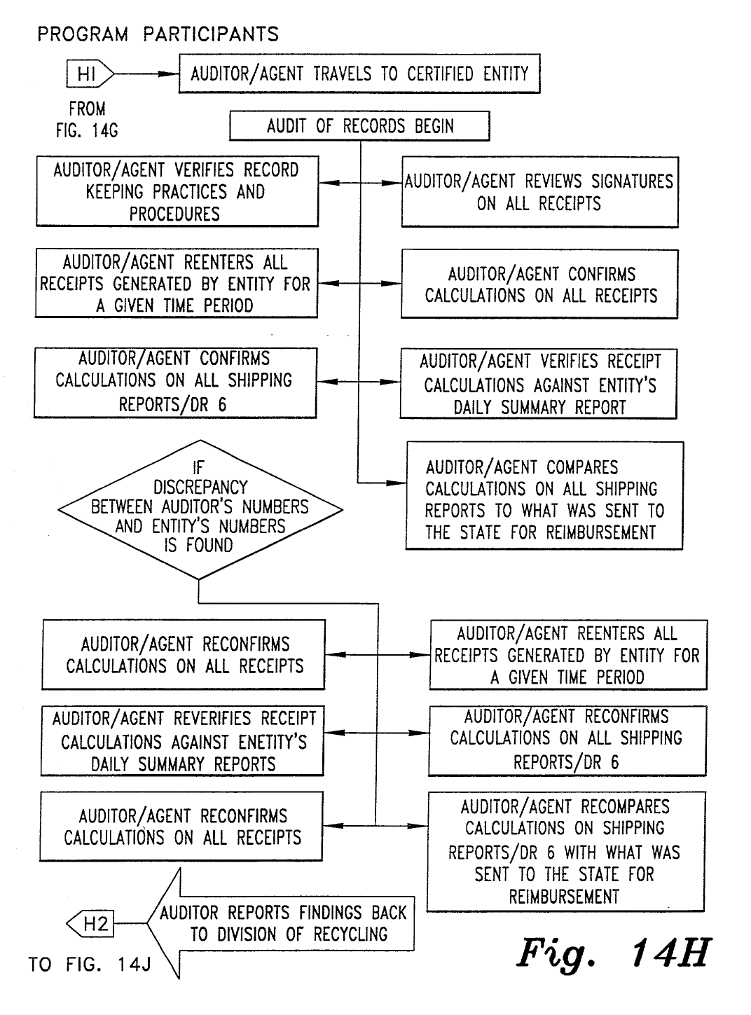

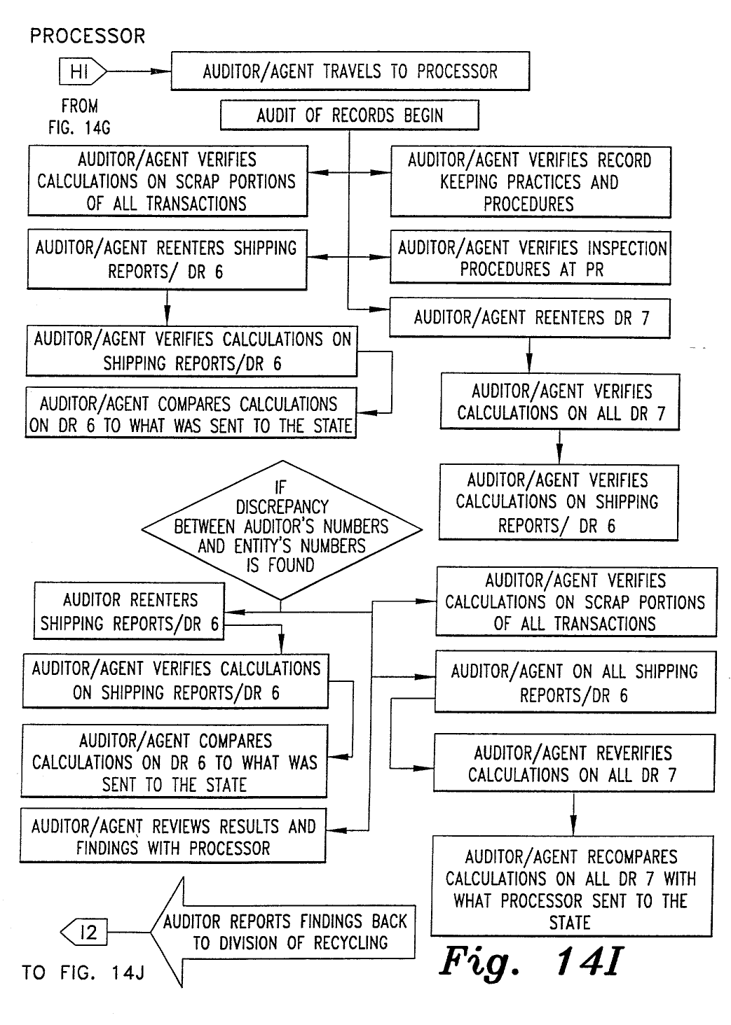

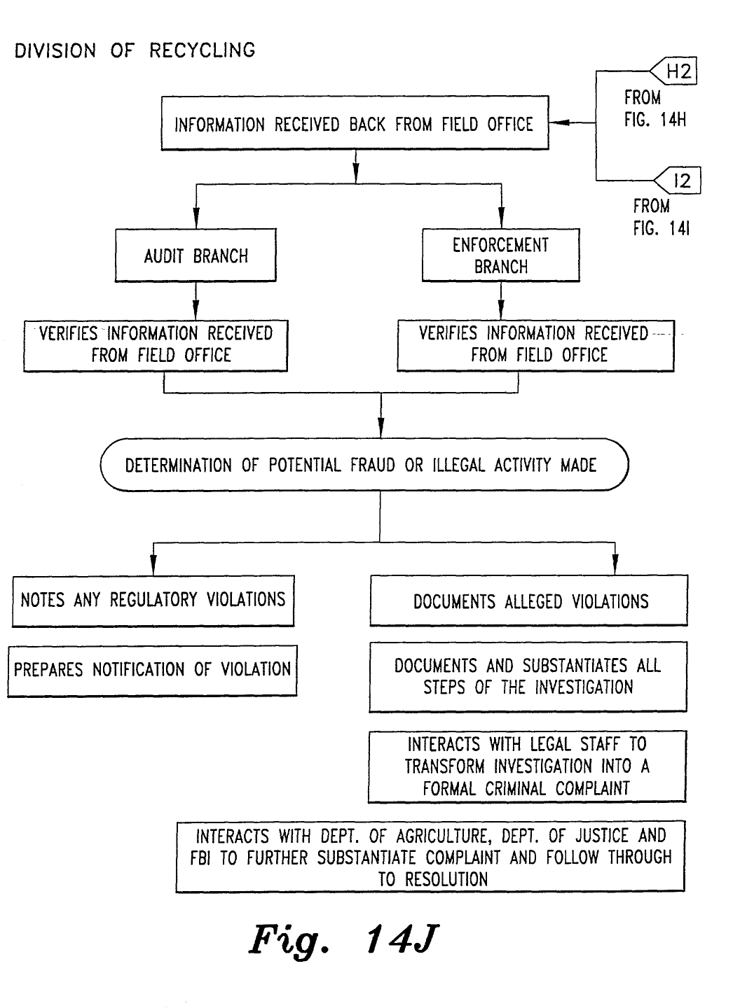

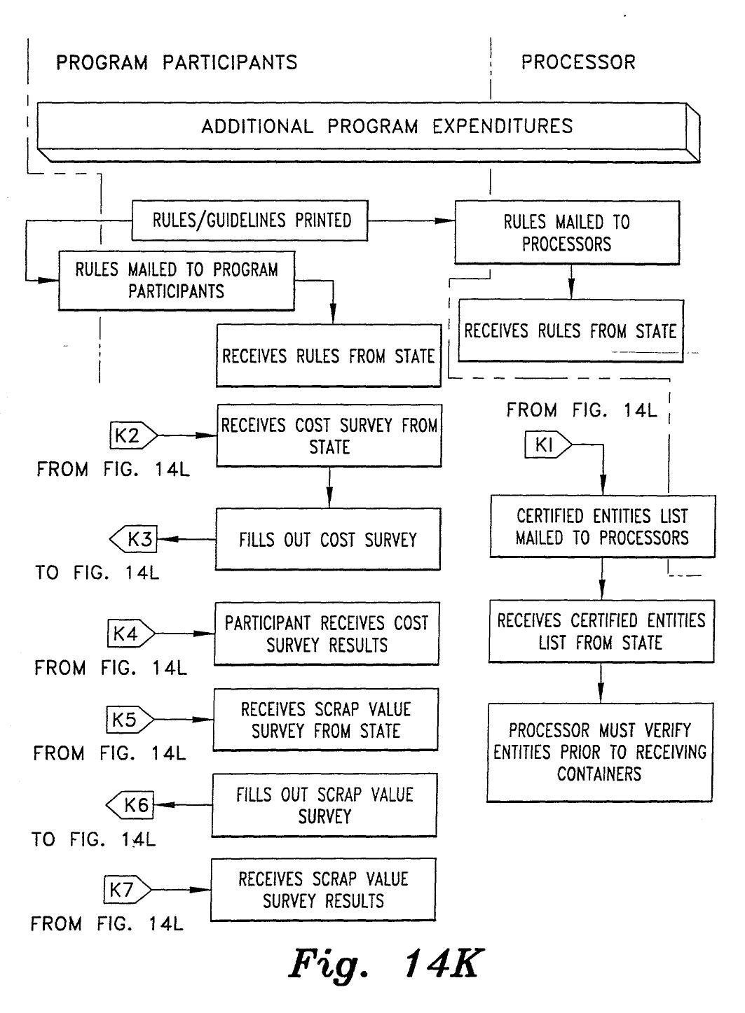

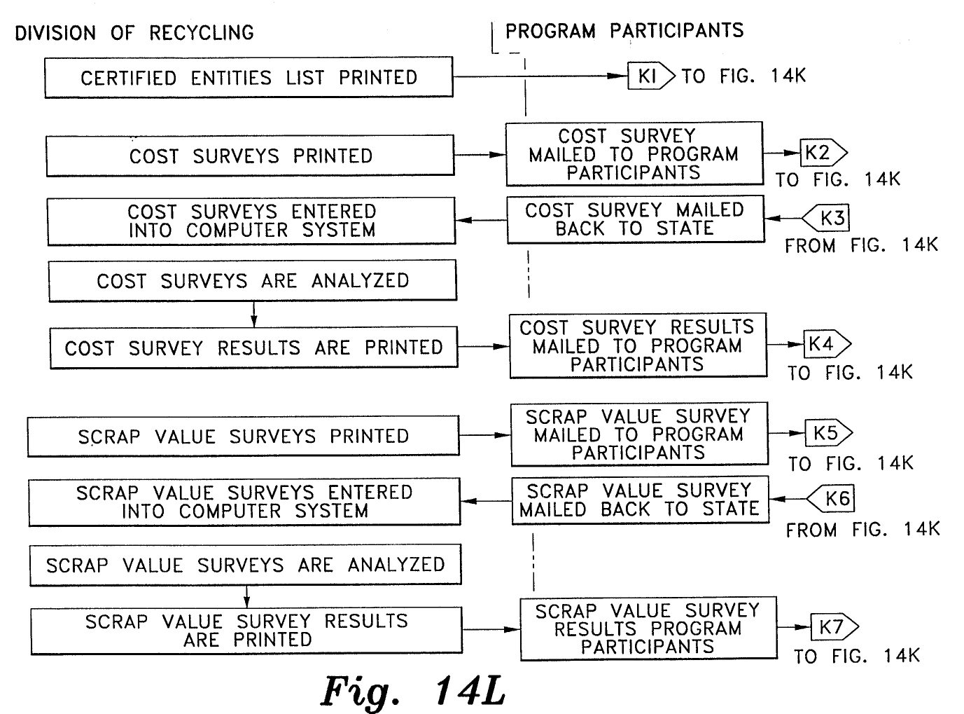

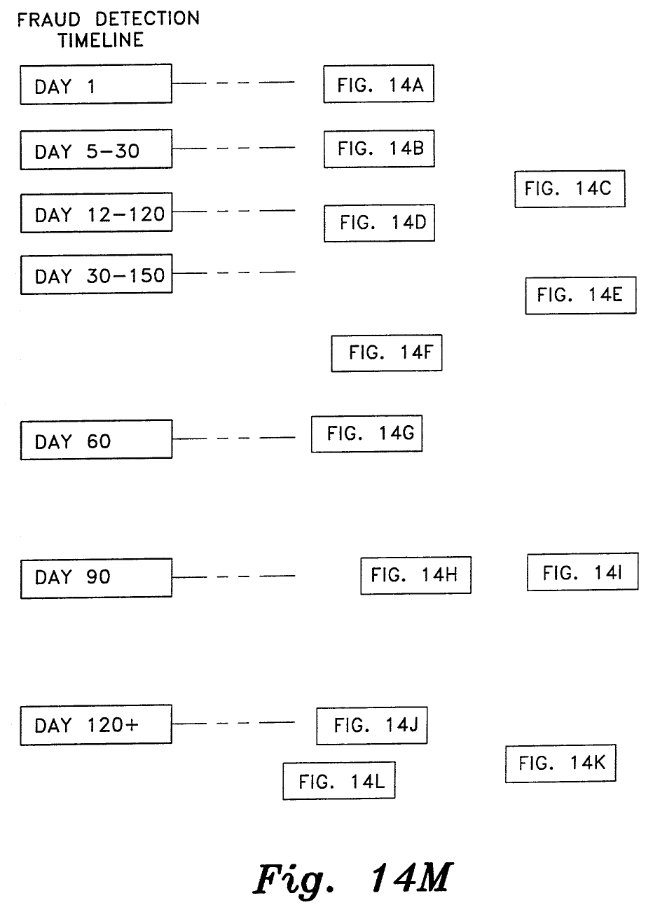

Another feature of the governmental agency program 28 is configured for enabling government employees to view information at the transaction level. Accordingly, an auditor will be capable of looking at each individual purchase ticket, each individual weight ticket, each transaction of the containers from start to finish. With the signature scanner, the Auditors will also be able to view the signatures on all transactions. Currently, the audit procedure is a long, lengthy and expensive process. The current auditing procedure is shown in FIG. 14. But a short summary of the process is provided here.

When a program participant is audited, an inspector or auditor arrives at the facility and verifies all of the participant's records. This step is done manually by entering all of the tickets and transactions into an Excel-like type spreadsheet. The entered data is also analyzed at this point. If there is a discrepancy found between the auditor's findings and the records of the participant, the auditor is required to recheck all of the transactions, manually. Since the participant is responsible for keeping the records, records are often missing or incomplete and disorganized. Reconstruction of what occurred may not even be possible. With our system, the audit process will be streamlined and more efficient because all of the Participants records and data will be available over the internet. The computer system has many pre-defined reports, plus auditors will be able to query the database for whatever information they need. Through forward looking algorithms, the system will proactively warn auditors of suspicious behavior, often before they suspect anything.

One of the primary functions that the system has is to prevent fraud. By capturing all of the transactions throughout the State and throughout the Program, our system dramatically reduces the potential for fraud and increases the chances of early detection. Through reports, Suspicious Activity Detection Algorithms, and the nightly gathering of information, the system can detect activity as it occurs and notify the proper authorities rapidly, reducing the time it takes to detect suspicious activity from 120 plus days to under 5.

To help detect fraud, the system will look for and analyze for the following:

Abnormally high or low container activity in an area and by Certified Entity as compared to its historical information.

Container Redemption volume versus containers sold in a given area. This analyzes the ratio of containers Redeemed to containers sold versus allowable levels.

Abnormal distributor activity—By monitoring the manufacturer and the distributor, the system will eliminate the distributor's ability to hide shipments to grocers and avoid paying the required fees.

Abnormal Recycling Center Activity—By comparing daily activity to historical activity, spikes or sudden drops in activity will be instantly recognized and reported. In addition, the system will detect things like if a Recycling Center tries to redeem more then it has purchased or the Recycling Center is taking containers to multiple Processors within an acceptable period of time.

The system will time stamp all of the transactions. So if a Program Participant attempts to enter false, erroneous, duplicate, or otherwise fraudulent information, our system will be able to detect it in several ways. First, if the tickets are being entered outside of normal business hours. Secondly, by the amount of time between tickets being entered. For example, the average transaction is going to take several seconds as the containers are placed on and off the scale. If the frequency of ticket entry is too rapid, the chances of the tickets being fraudulently generated by the Recycling Center is increased. Averages as well as peak and valley activity will be collected and used to compare activity on a daily basis to assist in suspicious activity detection.

Abnormal Consumer activity—By having all of the Recycling Centers hooked up to the same system, our system will be able to detect if a Consumer is taking containers to multiple recycling centers within an acceptable period of time. It will also track how many containers an individual redeems and compare it against allowable parameters. For example, no individual is allowed to redeem more then 500 pounds of aluminum cans per day. Individual customers will be tracked by there Driver's license information. The system will ask questions like, “Why would someone from San Diego be recycling three times last week in Los Angeles?”

The system is not limited to these reports and summaries. The Governmental agencies will be able to configure the system to provide them with reports and detection algorithms as they deem necessary.

It is to be understood that the present invention is not limited to the embodiments described above, but encompasses any and all embodiments within the scope of the following claims.

I claim:

1. An automated information processing system for collecting and analyzing transactional information pertaining to recycling of beverage containers, said system being communicatively connected to a beverage container collection establishment, a certified recycling establishment, a community service establishment, a curbside establishment, an end user establishment, a retail establishment, a distributor establishment, a container manufacturing establishment, and the Internet network, said information processing system comprising:
a first client means communicatively connected to the Internet network for producing reports, graphs, and charts of collected data, said first client means being dedicated for use exclusively by a governmental agency;
a second client means communicatively connected to the Internet network for processing and managing recycling data generated at a certified recycling establishment; and
a server communicatively connected to the Internet network for providing a central depository for collection and storage of data produced by the information processing system.

2. The automated information processing system recited in claim 1, wherein said second client means may further be used for sending the recycling data to said server.

3. The automated information processing system recited in claim 1 further comprising:
a third client means communicatively connected to the Internet network for recording the quantity and weight of beverage containers donated to a community service establishment.

4. The automated information processing system recited in claim 1 further comprising:
a third client means communicatively connected to the Internet network for monitoring the influx of beverage containers received by a curbside establishment.

5. The automated information processing system recited in claim 1 further comprising:
a third client means communicatively connected to the Internet network for monitoring a quantity of containers received by an end user's establishment.

6. The automated information processing system recited in claim 5, wherein said third client means may further be used for tracking movement of a beverage container from one end user to another end user.

7. The automated information processing system recited in claim 1 further comprising:
a third client means communicatively connected to the Internet network for totalling an amount of deposit money received by a retail establishment and forwarding said amount to said first client means.

8. The automated information processing system recited in claim 1 further comprising:
a third client means communicatively connected to the Internet network for monitoring a quantity of beverage containers received by the distributor establishment and a quantity shipped by a beverage container manufacturer.

9. The automated information processing system recited in claim 1 further comprising:
a third client means communicatively connected to the Internet network for periodically monitoring a quantity of containers manufactured, a quantity of containers sent to a particular distributor, and a quantity of containers that have been recycled.

10. An automated information processing system for collecting and analyzing transactional information pertaining to recycling of beverage containers, said system being communicatively connected to a beverage container collection establishment, a certified recycling establishment, a community service establishment, a curbside establishment, an end user establishment, a retail establishment, a distributor establishment, a container manufacturing establishment, and the Internet network, said information processing system comprising:
a first client means communicatively connected to the Internet network for producing reports, graphs, and charts of collected data, said first client means being dedicated for use exclusively by a governmental agency;
a second client means communicatively connected to the Internet network for processing and managing recycling data generated at a certified recycling establishment; and
a third client means communicatively connected to the Internet network for recording the quantity and weight of beverage containers donated to a community service establishment;
a fourth client means communicatively connected to the Internet network for monitoring the influx of beverage containers received by a curbside establishment;
a fifth client means communicatively connected to the Internet network for monitoring a quantity of containers received by an end user's establishment;
a sixth client means communicatively connected to the Internet network for totalling an amount of deposit money received by a retail establishment and forwarding said amount to said first client means;
a seventh client means communicatively connected to the Internet network for monitoring a quantity of beverage containers received by the distributor establishment and a quantity shipped by a beverage container manufacturer;
a eighth client means communicatively connected to the Internet network for periodically monitoring a quantity of containers manufactured, a quantity of containers sent to a particular distributor, and a quantity of containers that have been recycled; and
a server communicatively connected to the Internet network for providing a central depository for collection and storage of data produced by the information processing system;

11. The automated information processing system recited in claim 10, wherein said fifth client means may further be used for tracking movement of a beverage container from one end user to another end user.
